(19) United States
(12) Patent Application Publication
(10) Pub. No.: US 2002/0099618 A1
(43) Pub. Date: Jul. 25, 2002

(54) Vehicle lease exchange method & system

(76) Inventor: Sergio Stiberman, Golden Beach, FL (US)

Correspondence Address: GREENBERG TRAURIG, P.A., 1221 Brickell Avenue, Miami, FL, 33131, US

(21) Appl. No.: 09/943,576

(22) Filed: Aug. 30, 2001

Related U.S. Application Data
(60) Provisional application No. 60/228,984, filed on Aug. 30, 2000.

(51) Int. Cl. G06F 17/60

(52) U.S. Cl. 705/26

(57) ABSTRACT

The present invention is a computerized vehicle lease exchange system and method, whereby prospective leased vehicle transferors and prospective leased vehicle transferees can complete leased vehicle transfer transactions electronically and whereby the prospective leased vehicle transferor can apply for and obtain insurance to protect against liability arising from a default by the leased vehicle transferee under the transferred vehicle lease.

### BACKGROUND OF THE INVENTION

The present invention relates to methods and systems for engaging in business transactions via the Internet. More particularly, the present invention relates to an Internet-based leased vehicle exchange method and system.

With the growth of the Internet, businesses have begun establishing online systems for transacting business. There are several prior art electronic sales and transaction processing methods and systems for general applications. For example, U.S. Pat. No. 5,664,115 to Fraser is directed to an interactive computer system to match buyers and sellers of real estate, businesses and other property using the Internet. This invention is essentially a bulletin board searching and screening system whereby purchasers can search for goods and sellers can screen buyers.

Similarly, U.S. Pat. No. 5,732,400 to Mandler et al. is directed to a system and method enabling online transactional services among sellers and buyers having no previous relationship with each other. The system is essentially a seller's broker system, including a financial clearinghouse for receiving requests for goods or services from a buyer and making a real-time risk classification of the buyer using an online repository of credit information. Approved buyers send requests for quotes through the financial clearinghouse to sellers with respect to particular goods and sellers then respond to the requests. The buyer then makes a purchase selection and the financial clearinghouse transmits the purchase amount to the seller and an invoice to the buyer.

Another prior art example is U.S. Pat. No. 5,842,178 to Giovannoli, which is directed to a computerized system for processing requests for quotation for goods and services between buyers and sellers by filtering buyer requests to sellers with products matching the buyers' specified criteria rather than by compiling a database of available goods or services.

Still other prior art systems include those described in U.S. Pat. No. 5,870,717 to Wiecha and U.S. Pat. No. 5,319,542 to King, Jr. et al., both of which are directed to systems for ordering goods or services over computer networks using electronic catalogs.

Prior art methods fail to address and resolve the specific combination of needs and problems associated with vehicle leasing, a combination of needs and problems that is not present with sales of other types of goods. A lessee normally is not able to assign a vehicle lease because of the risks involved due to the lessee remaining personally obligated under a lease while no longer using the vehicle. Additionally such a transaction would require more interaction between individuals (the consumer lessor and the consumer transferee of the leased vehicle). The system and method of the present invention addresses these needs.

### SUMMARY OF THE INVENTION

The present invention is a computerized lease exchange system and method. The system of the present invention comprises means for receiving vehicle and lease information submitted electronically by or on behalf of prospective leased vehicle transferors and storing said information in a searchable database; means for providing said vehicle and lease information electronically to prospective leased vehicle transferees in response to electronic queries to said searchable database submitted by or on behalf of prospective leased vehicle transferees; means for receiving vehicle selection information submitted electronically by or on behalf of prospective leased vehicle transferors; means for notifying electronically prospective leased vehicle transferors whose vehicles are selected by prospective leased vehicle transferees of said selection so that the parties can negotiate and complete a leased vehicle transfer transaction; means for receiving and processing insurance application information submitted electronically by or on behalf of either prospective leased vehicle transferors or prospective leased vehicle transferees with respect to vehicles selected by said prospective leased vehicle transferees for insurance covering the prospective leased vehicle transferor's liability under the prospective leased vehicle transferor's lease agreement for said vehicle in the event of lease payment defaults by the prospective leased vehicle transferee after transfer of said vehicle and lease to said transferee; means for submitting said insurance application information to one or more insurers for application processing and approval; and means for arranging for vehicle and lease transfer and insurance document delivery, payment and vehicle delivery.

The computerized method for transferring a leased vehicle from a prospective leased vehicle transferor to a prospective leased vehicle transferee of the present invention comprises: receiving vehicle and lease information submitted electronically by or on behalf of prospective leased vehicle transferors and storing said information in a searchable database; providing said vehicle and lease information electronically to prospective leased vehicle transferees in response to electronic queries to said searchable database submitted by or on behalf of prospective leased vehicle transferees; receiving vehicle selection information submitted electronically by or on behalf of prospective leased vehicle transferors; notifying electronically prospective leased vehicle transferors whose vehicles are selected by prospective leased vehicle transferees of said selection so that the parties can negotiate and complete a leased vehicle transfer transaction; receiving and processing insurance application information submitted electronically by or on behalf of either prospective leased vehicle transferors or prospective leased vehicle transferees with respect to vehicles selected by said prospective leased vehicle transferees for insurance covering the prospective leased vehicle transferor's liability under the prospective leased vehicle transferor's lease agreement for said vehicle in the event of lease payment defaults by the prospective leased vehicle transferee after transfer of said vehicle and lease to said transferee; submitting said insurance application information to one or more insurers for application processing and approval; and arranging for vehicle and lease transfer and insurance document delivery, payment and vehicle delivery.

The system provides a web-based service for individuals and companies wishing to terminate a lease, such as a vehicle lease, before its contractual due date, and for customers looking for a short-term lease with few out-of-pocket expenses. The system utilizes known methods of Internet communication and system hardware. Users can search a database of available vehicles, make selections, arrange for vehicle inspection and complete lease transactions online using the system.

### BRIEF DESCRIPTION OF THE DRAWINGS

FIG. 1 is a diagram of the basic system architecture of the system of the present invention.

FIG. 2 depicts a sample home page screen of the system of the present invention in a preferred embodiment.

FIG. 3 depicts a sample post your vehicle screen of the system of the present invention in a preferred embodiment.

FIG. 4 depicts a sample new transferor user registration screen of the system of the present invention in a preferred embodiment.

FIG. 5 depicts a sample new registered transferor welcome screen of the system of the present invention in a preferred embodiment.

FIG. 6 depicts a sample transferor user vehicle information entry screen of the system of the present invention in a preferred embodiment.

FIG. 7 depicts an additional sample transferor user vehicle information screen of the system of the present invention in a preferred embodiment.

FIG. 8 depicts a sample transferor user lease information entry screen of the system of the present invention in a preferred embodiment.

FIG. 9 depicts a sample transferor user lease contact information entry screen of the system of the present invention in a preferred embodiment.

FIG. 10 depicts a sample transferor user vehicle/lease listing preview screen of the system of the present invention in a preferred embodiment.

FIG. 11 depicts a sample transferor user vehicle listing payment information entry screen of the system of the present invention in a preferred embodiment.

FIG. 12 depicts a sample transferor user vehicle listing posting confirmation screen of the system of the present invention in a preferred embodiment.

FIG. 13 depicts a sample transferor user login screen of the system of the present invention in a preferred embodiment.

FIG. 14 depicts a sample transferor user login confirmation screen of the system of the present invention in a preferred embodiment.

FIG. 15 depicts a sample transferor user listing maintenance screen of the system of the present invention in a preferred embodiment.

FIG. 16 depicts a sample transferor user listing posting term extension screen of the system of the present invention in a preferred embodiment.

FIG. 17 depicts a sample user lease transaction screen of the system of the present invention in a preferred embodiment.

FIG. 18 depicts a sample user messaging screen of the system of the present invention in a preferred embodiment.

FIG. 19 depicts a sample transferee user vehicle wish list summary screen of the system of the present invention in a preferred embodiment.

FIG. 20 depicts a sample transferee user wish list information screen of the system of the present invention in a preferred embodiment.

FIG. 21 depicts a sample transferee user saved prior vehicle listing search results screen of the system of the present invention in a preferred embodiment.

FIG. 22 depicts a sample transferee user information management screen of the system of the present invention in a preferred embodiment.

FIG. 23 depicts a sample vehicle dealer user registration information entry screen of the system of the present invention in a preferred embodiment.

FIG. 24 depicts a sample vehicle dealer user login screen of the system of the present invention in a preferred embodiment.

FIG. 25 depicts a sample vehicle dealer user welcome screen of the system of the present invention in a preferred embodiment.

FIG. 26 depicts a sample vehicle dealer user vehicle listing information entry screen of the system of the present invention in a preferred embodiment.

FIG. 27 depicts a sample vehicle dealer user posted vehicle listing screen of the system of the present invention in a preferred embodiment.

FIG. 28 depicts a sample vehicle dealer user customer lead management screen of the system of the present invention in a preferred embodiment.

FIG. 29 depicts a sample vehicle dealer user messaging screen of the system of the present invention in a preferred embodiment.

FIG. 30 depicts a sample transferee user online credit application information entry screen of the system of the present invention in a preferred embodiment.

FIG. 31 depicts a sample transferee user vehicle listing search screen of the system of the present invention in a preferred embodiment.

FIG. 32 depicts a sample transferee user vehicle search results screen of the system of the present invention in a preferred embodiment.

FIG. 33 depicts a sample transferee user vehicle listing screen of the system of the present invention in a preferred embodiment.

FIG. 34 depicts a sample transferee user login screen of the system of the present invention in a preferred embodiment.

FIG. 35 depicts a sample transferee user system lease transfer procedures information screen of the system of the present invention in a preferred embodiment.

FIG. 36 depicts a sample transferee user credit application information entry screen of the system of the present invention in a preferred embodiment.

FIG. 37 depicts a sample transferee user lease transaction screen of the system of the present invention in a preferred embodiment.

FIG. 38 depicts a sample transferee user messaging screen of the system of the present invention in a preferred embodiment.

FIG. 39 depicts a sample transferee user “ad a wish” screen of the system of the present invention in a preferred embodiment.

### DESCRIPTION OF A PREFERRED EMBODIMENT

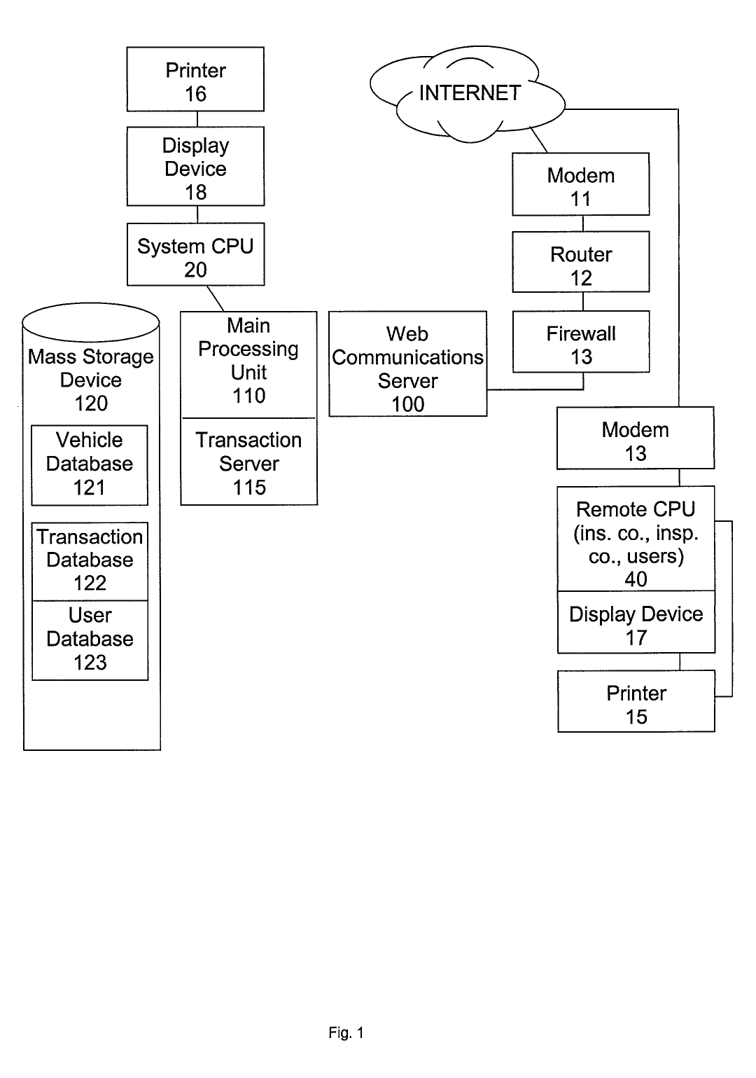

Referring now to FIG. 1, the primary elements of the computer network architecture of the system of the present invention in a preferred embodiment are depicted in the form of a block diagram. The system exchanges data with a plurality of remote terminals via known methods utilized for Internet communications, namely, data transmission across telephone and data transmission lines. Data transmission on the system end utilizes a gateway that interfaces the system to remote terminals with a protocol understood by said remote terminals or intermediary equipment connected thereto. For example, in a preferred embodiment of the present system, data is transmitted to and from the system via the Internet using transmission control protocol/Internet protocol (“TCP/IP”).

As depicted in FIG. 1, the system of the present invention in a preferred embodiment comprises an Internet Web communications server 100 communicating with consumers as well as optionally with dealers, financing/leasing insurance and vehicle inspection companies through the Internet and also with the other system-side components, said system-side components further comprising a mass storage device 120 having, in a preferred embodiment, a vehicle database 121, transaction database 122 and user database 123, and a main processing unit 110 with a transaction server 115. The system may also include the use of one or more routers 12 and firewalls 13 for creation of secure private communications networks between the system and users and between the system and financing/leasing, insurance and/or inspection companies.

The vehicle database 121 is a relational database containing various categories of motor vehicle data, such as make, model, year, body style, exterior color, interior type and color, and most common vehicle options (e.g., air conditioning, automatic transmission, radio, among other known options) for the various makes and models of motor vehicles offered vehicle database as well as lease term data, and is preferably resident in a structured query language (“SQL”) server. The SQL is programmed to allow searching of the vehicle database 21 based on consumer specified vehicle criteria.

The transaction server 115 in the preferred embodiment of the present system described in FIG. 1 comprises a central processing unit and associated read-only memory connected along data and address bus lines to a random access memory and to the central motor vehicle database. The transaction server 115 may also have internal transaction data storage capability or alternately transaction data may be stored in a separate storage device. These components are operatively connected to commonly used input/output (“I/O”) interface devices that control various corresponding I/O devices. These I/O devices may include such conventional elements as one or more video display devices 17 and 18, keyboards, printers, mouses and digitizers or scanners.

As with other computer systems, the read-only memory of the transaction server provides software instructions to enable said transaction server 115 to execute necessary software applications programs performing the system functions, including control/interfacing with the system Internet Web communications server 100, communications with leased vehicle transferor and transferee remote terminals, dealers, leasing companies, insurance company and inspection company remote terminals, links to third party websites where system advertisements are placed, and if necessary, lender or leasing company remote terminals; vehicle database management, searching and updating; controlling event-driven algorithms through which the system processes transactions appropriately based on the directions indicated by consumer action (“events”) such as pressing keys or clicking a mouse; motor vehicle graphical presentation applications to produce online depictions of actual motor vehicles identified from the vehicle database 121 as fitting a customer's specified criteria; purchase or lease order, purchase or lease agreement and other documentation generators. Other optional applications include data encryption/decryption and electronic signature generation and authentication applications, as well as electronic payment applications. The messaging means can be any of the various generally known forms, including, without limitation, e-mail as well as peer-to-peer and instant messaging protocols.

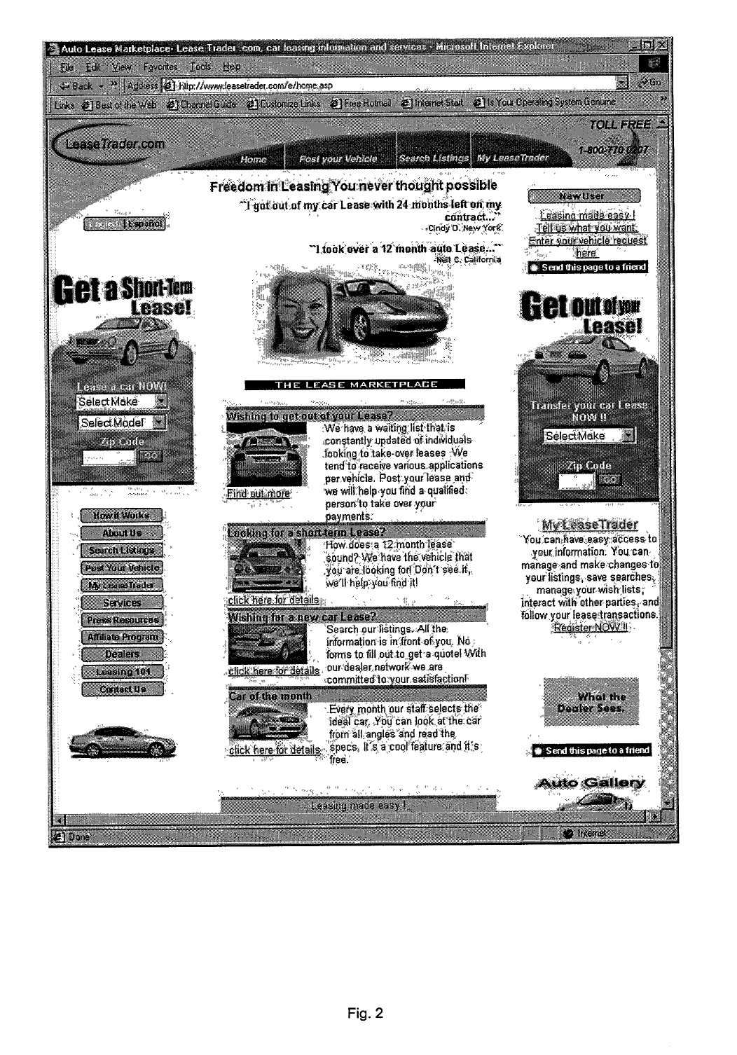

Referring now to FIG. 2, the website of the present system served by the Internet Web communications server 100 in a preferred embodiment is operatively connected to the Internet and has at least a first home page remotely accessible by consumers. Under the present system, first time consumers will preferably access the system in response to a generic advertisement placed on another website, and then enter a query screen rather than a home page screen. Alternately, consumers may access the website of the present system directly and view the website homepage for options that can be selected to proceed into the system. Under either alternative, dealers are not identified until the consumer has committed to purchase or lease a vehicle selected from the vehicle database 121. The system, in a preferred embodiment, has a plurality of screens whereby leased vehicle transferors, transferees, dealers and other users enter and retrieve information pertaining to leased vehicle transfers. Certain screens are provided for use by prospective transferors, while others are provided for dealers, prospective transferors and other users. As used herein, a “transferor user” or “prospective leased vehicle transferor” is a user of the system seeking to transfer his/her/its leased vehicle, and a “transferee user” or “prospective leased vehicle transferee” is a user of the system seeking to acquire a leased vehicle assuming the related vehicle lease.

Users Seeking to Transfer a Lease Vehicle Prior to Lease Termination

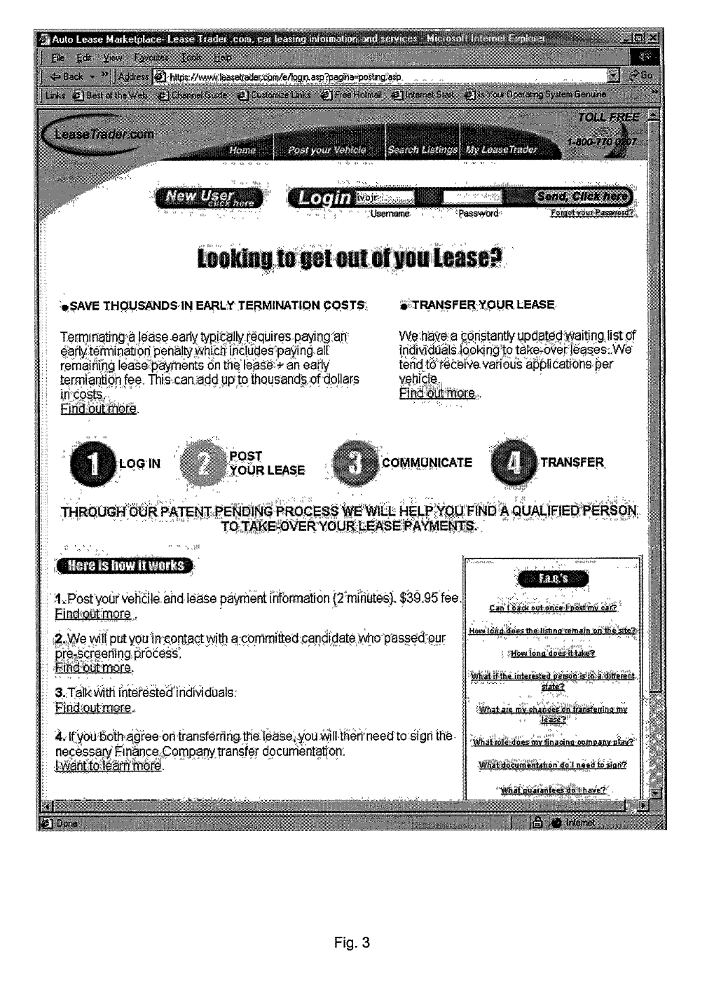

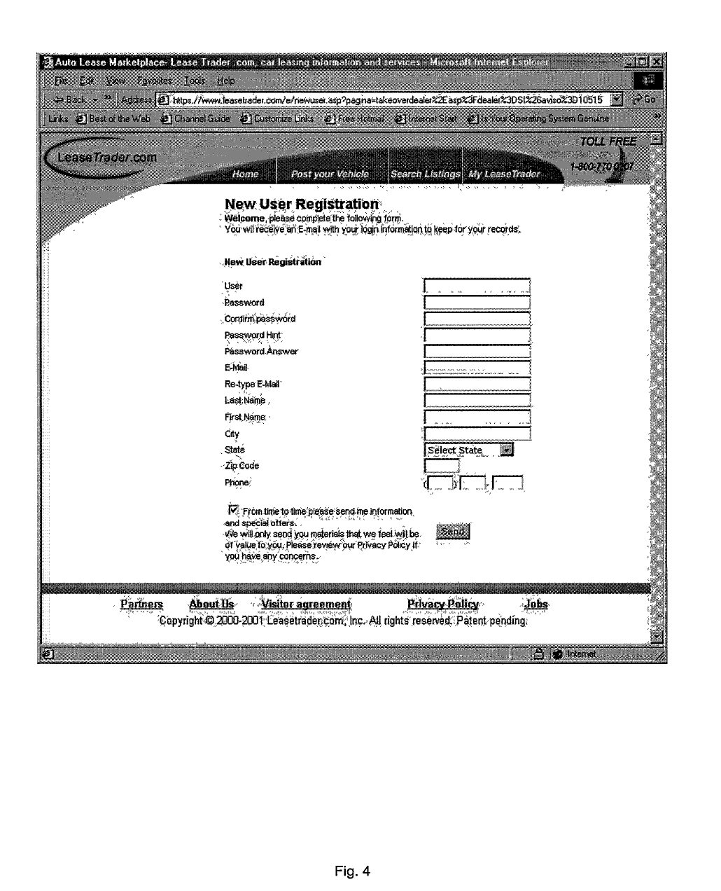

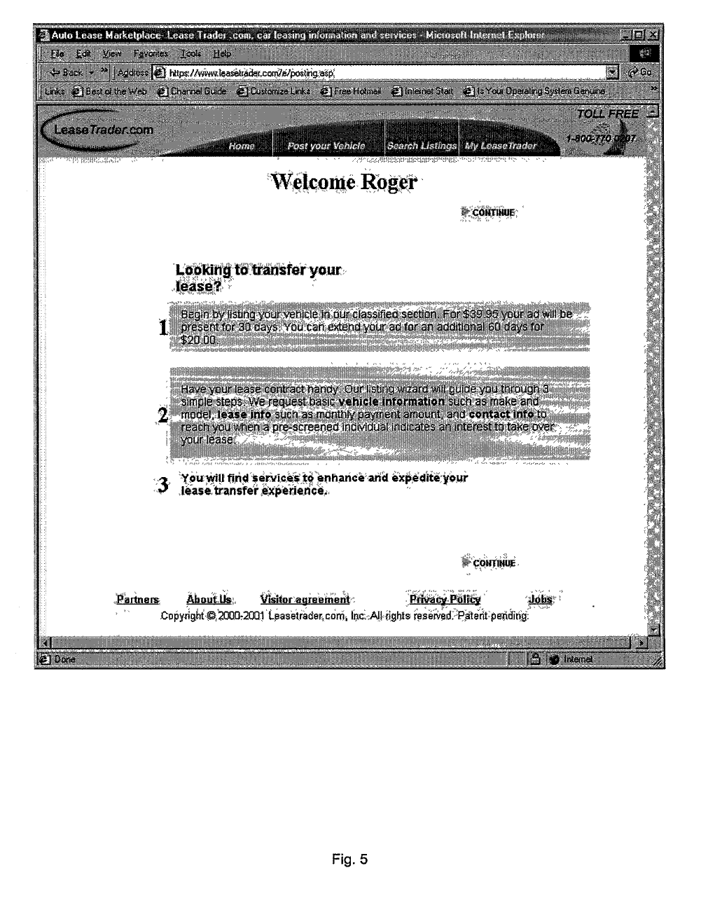

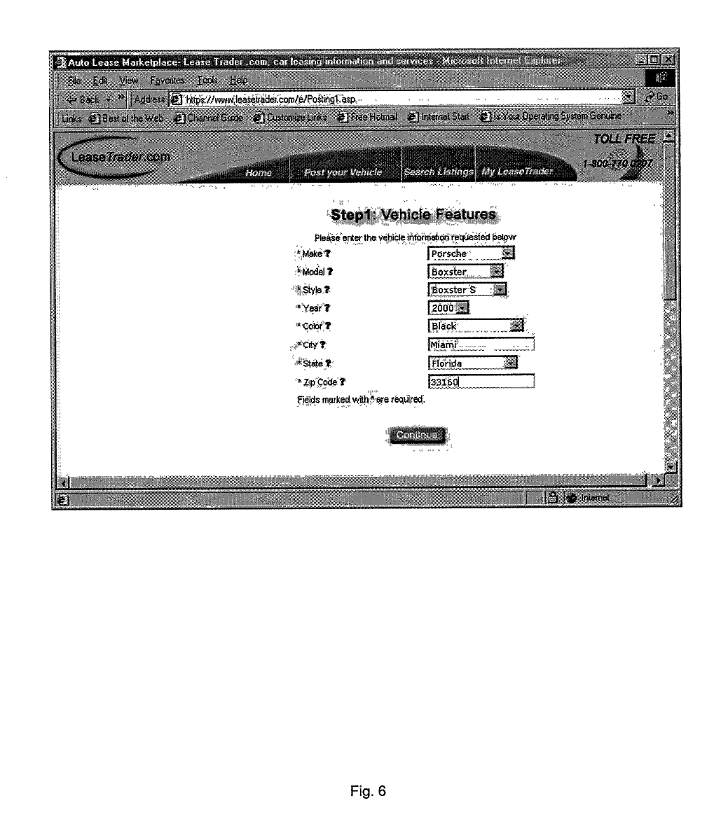

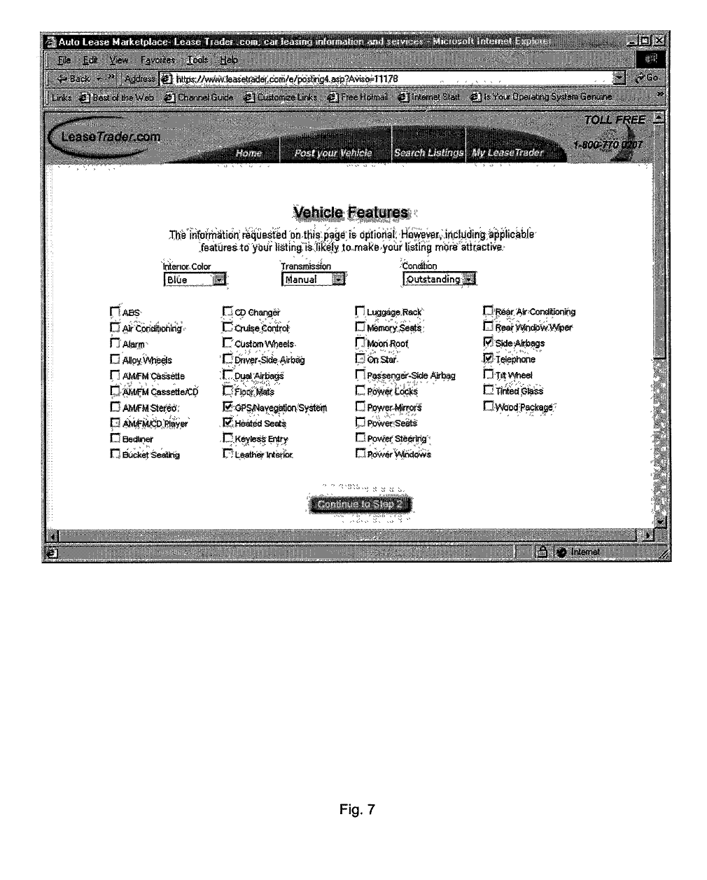

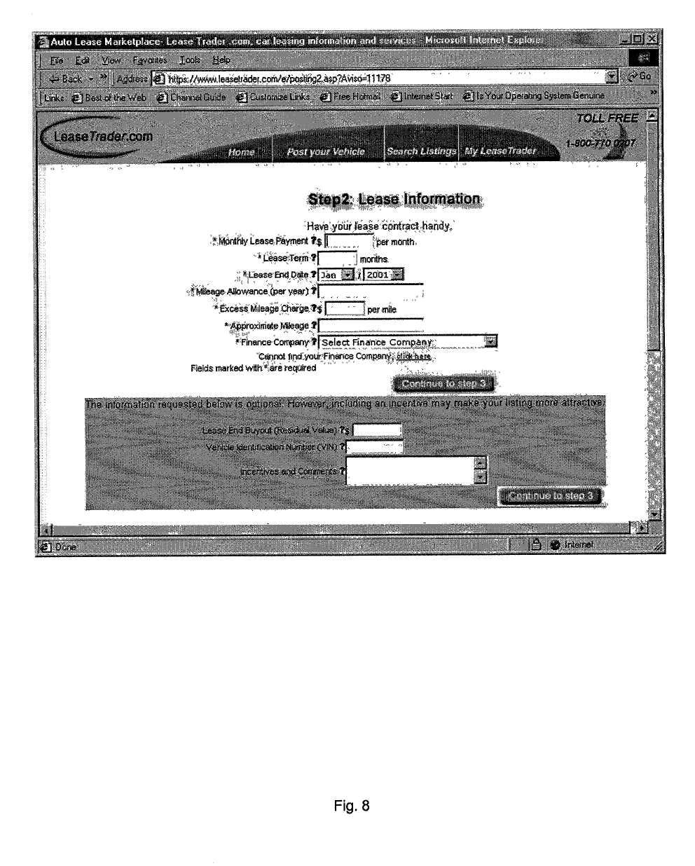

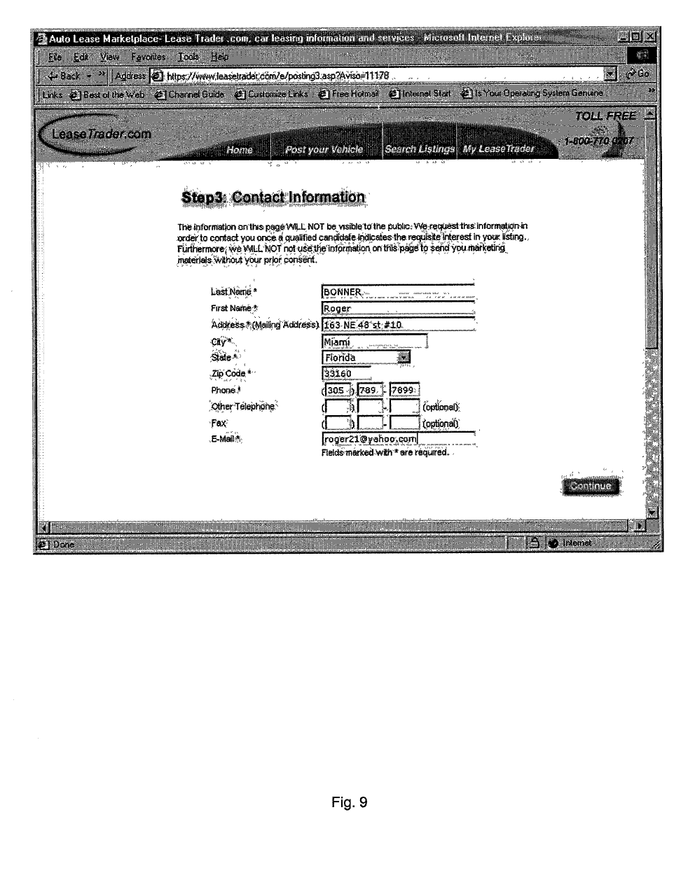

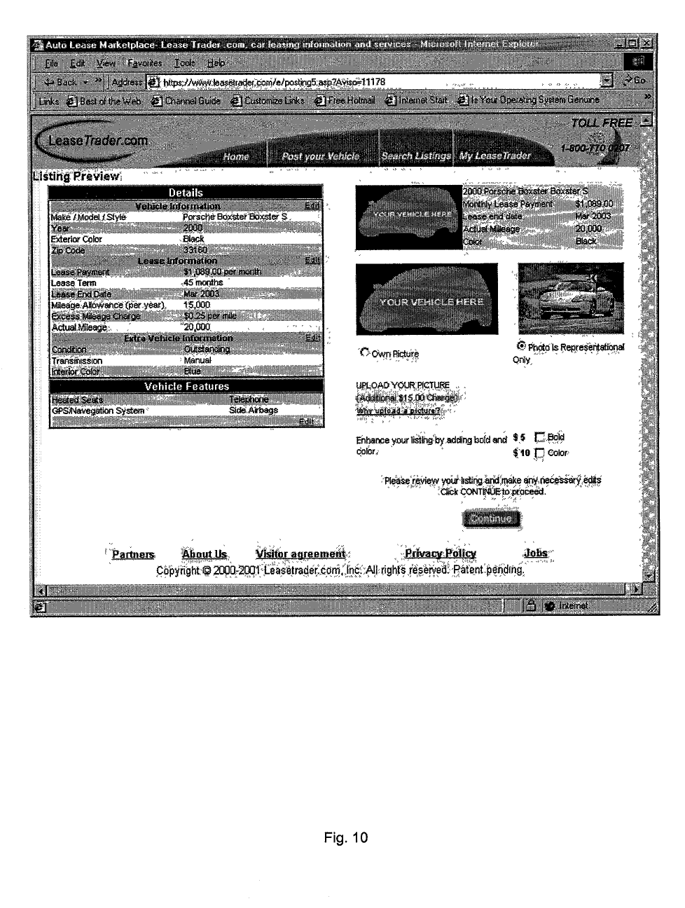

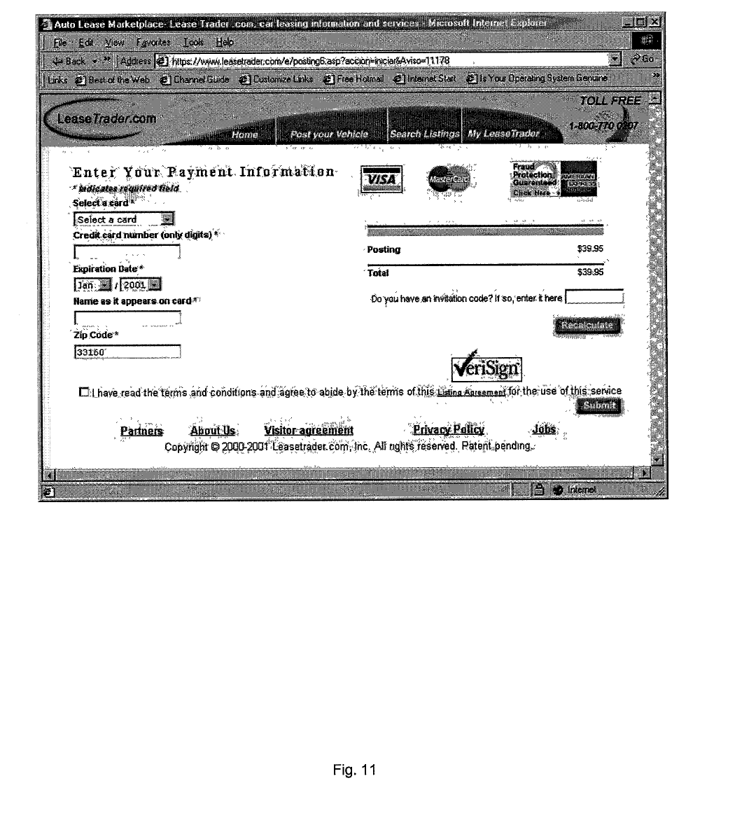

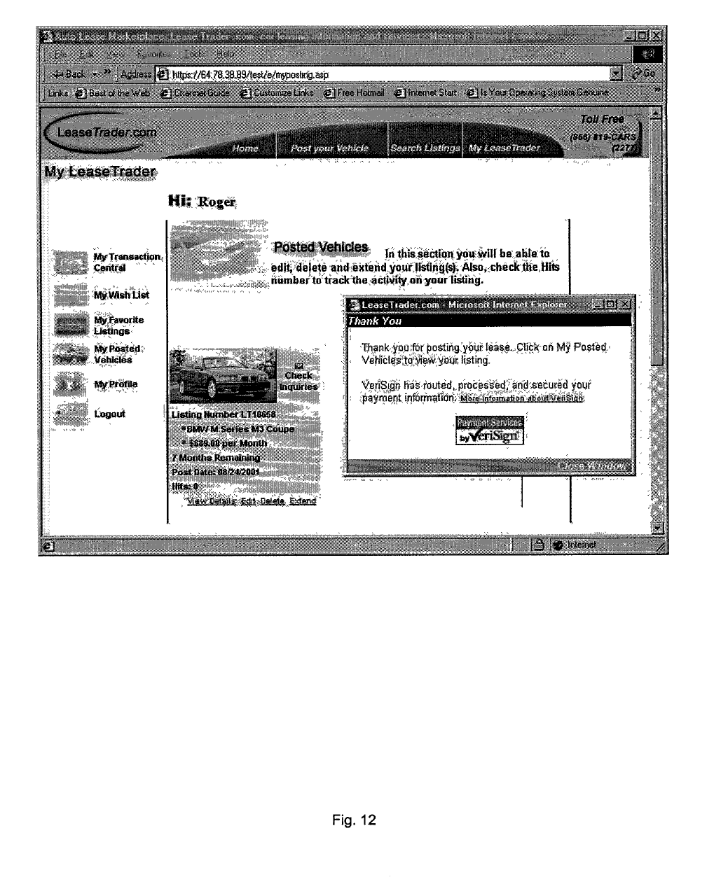

Referring now to FIG. 3, prospective transferor users seeking to transfer a leased vehicle prior to the Lease end date select the “Post Your Lease” option on the system, which system is referred to in the figures as “LeaseTrader.com.” The system verifies if the user is logged in. If not, referring to FIG. 4, the system prompts the user to enter login information and the new user is added to the user database. After a new user has registered with the system, a welcome screen such as the one depicted on FIG. 5 appears. Referring to FIGS. 6-9, transferor users seeking to assign a lease contract with a financial institution to another party can post their vehicles and lease terms on the system website by entering the data in response to prompts. The information is stored in a searchable database included in the system. The system provides leased vehicle information such as: make and model of vehicle, color, miles, year, options on vehicle, time left in lease contract, miles left on the lease contract, location (city and state or zip) of vehicle, monthly payments, picture and any incentives offered by potential transferors to potential transferees, name and address of leasing company, transferor's account number, vehicle VIN number, and transferor's contact information (address, phone, fax and e-mail). Persons seeking to assign their leases can obtain an insurance policy protecting them from a possible default by the transferee in the lease payments. This is usually the main disincentive for assigning vehicle leases—the original lessor remains personally obligated under the lease but no longer has control of the vehicle. The information is stored in the appropriate database of the System's mass storage device 120 and a vehicle listing preview screen such as the one depicted in FIG. 10 is displayed. The transferor user is then prompted to enter listing payment information through a screen such as depicted in FIG. 11. A listing fee is charged, such as, for example but not by way of limitation, a basic listing fee, as well as additional fees to include actual photograph of vehicle, for color listings, or for bold listings. A listing confirmation screen such as that depicted in FIG. 12. The vehicle is added to the vehicle database 121 and is made accessible for online searches.

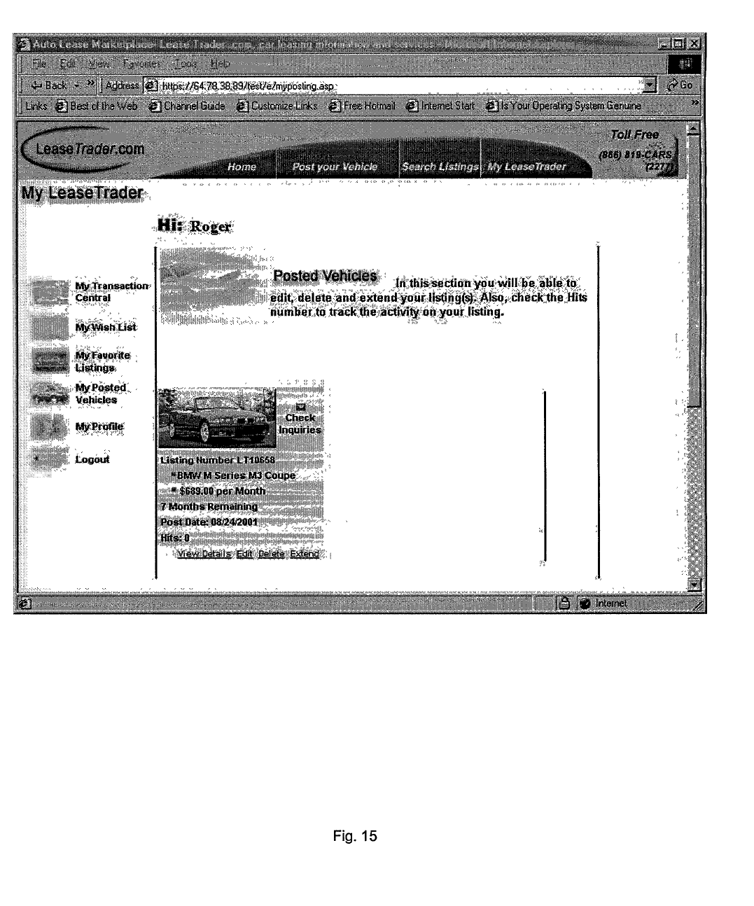

The system automatically notifies all individuals who filled out a prior request (“Wish List”) for the exact same vehicle or similar match. The system also provides via e-mail enhanced posting features (color, bold, or actual photograph) not selected during the posting process. The system also automatically notifies transferor users via e-mail to renew listing prior to reaching expiration via a screen such as that depicted in FIG. 15.

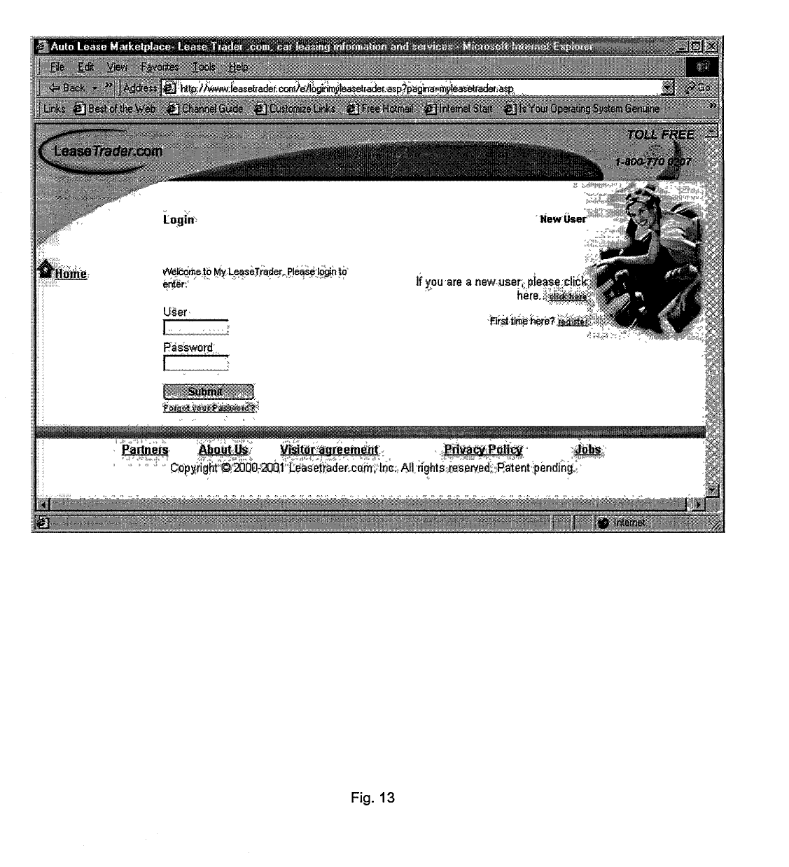

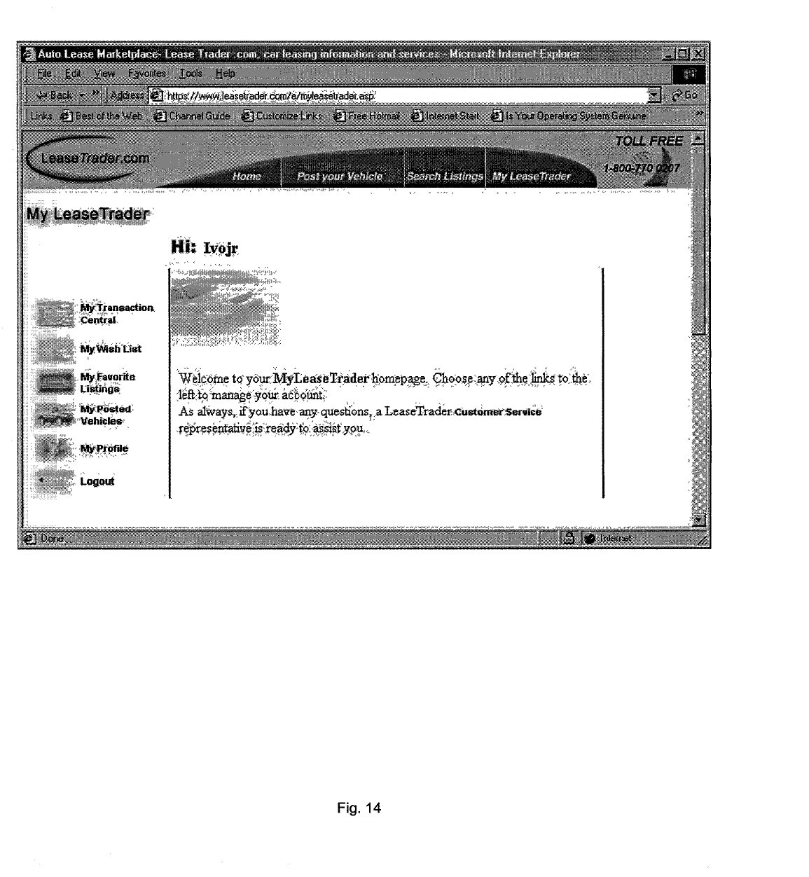

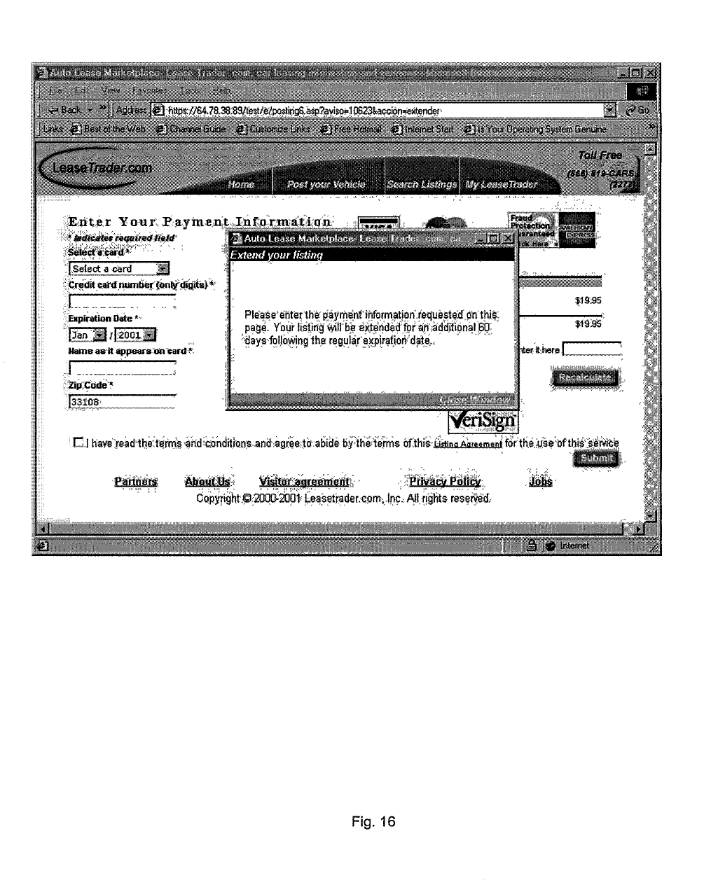

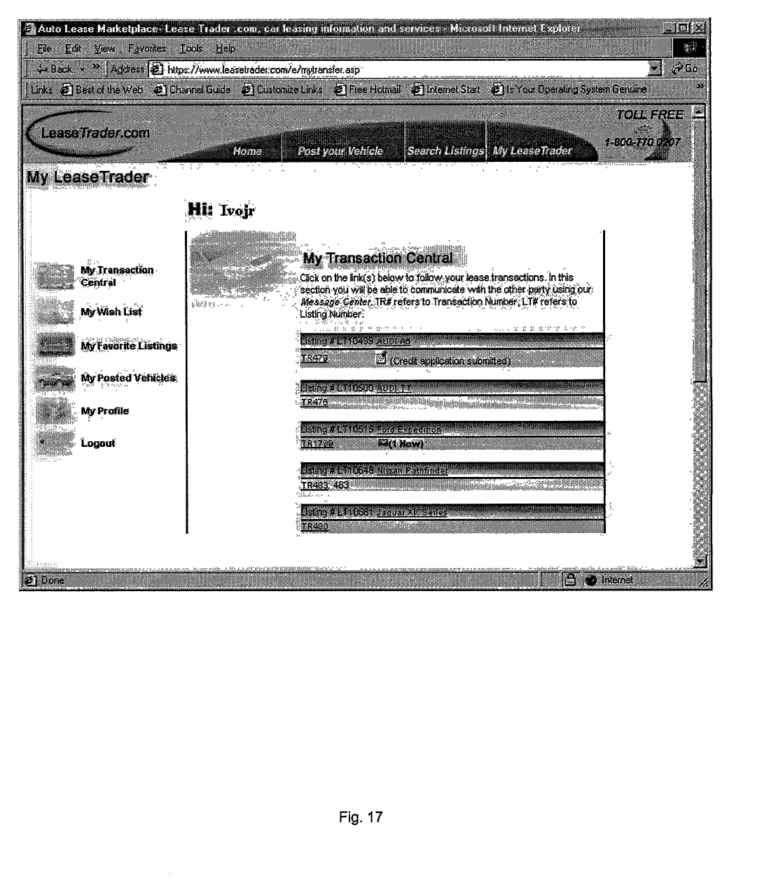

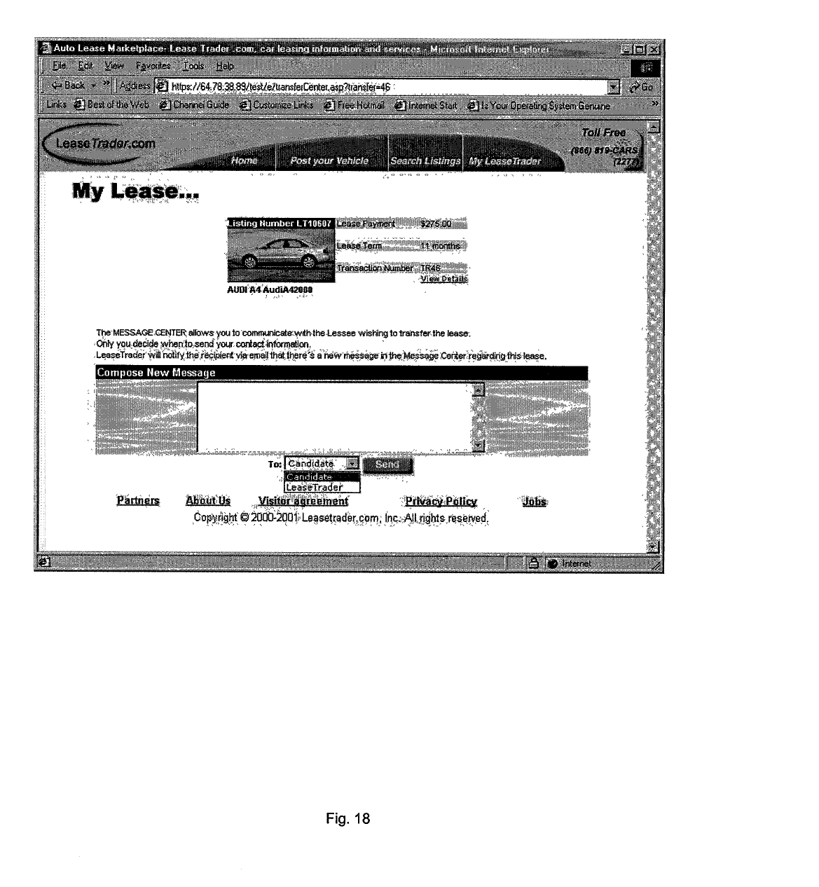

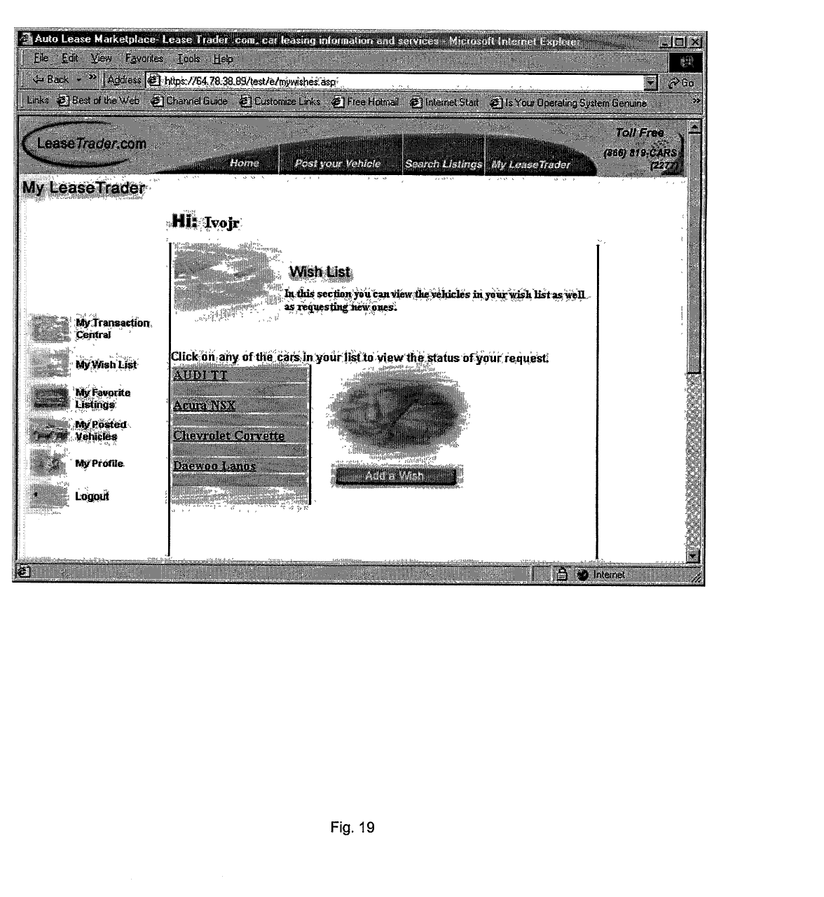

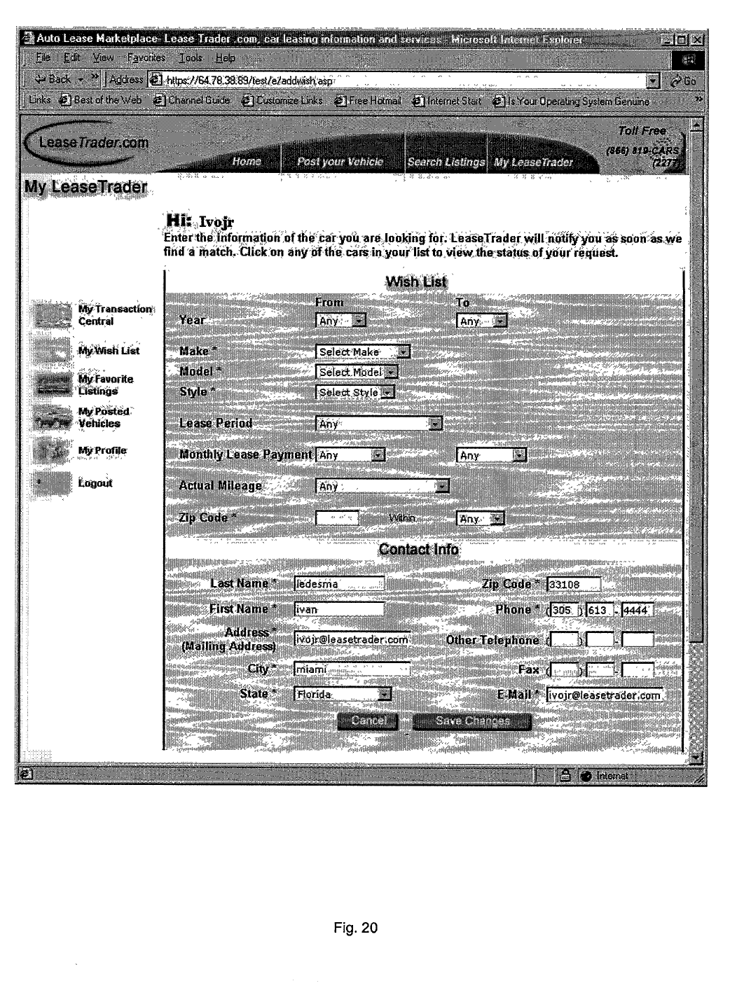

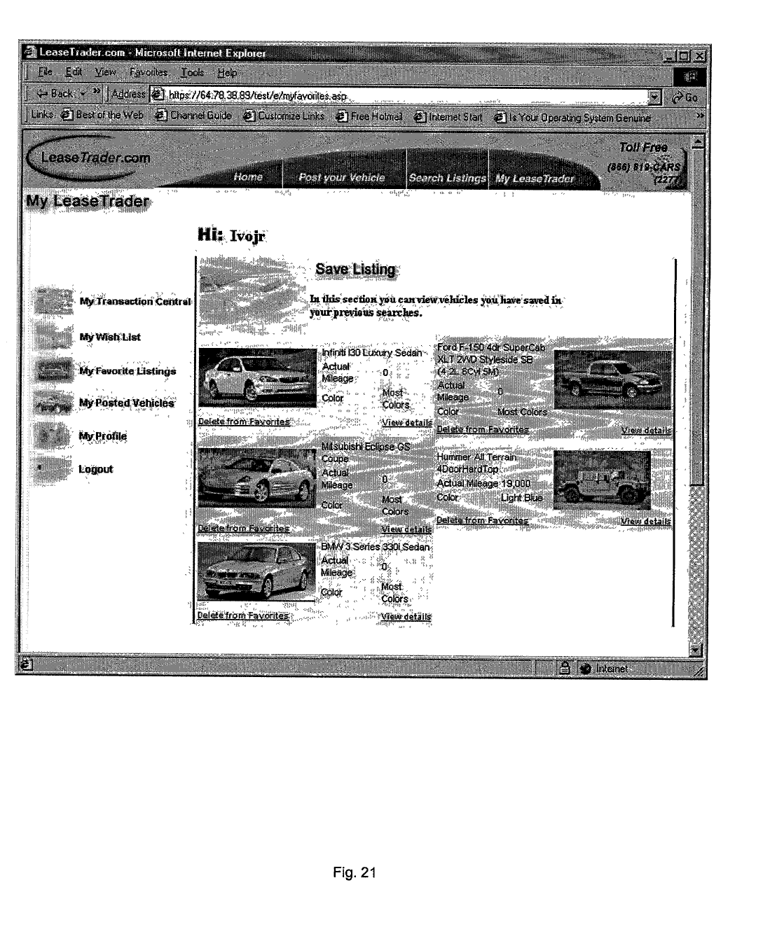

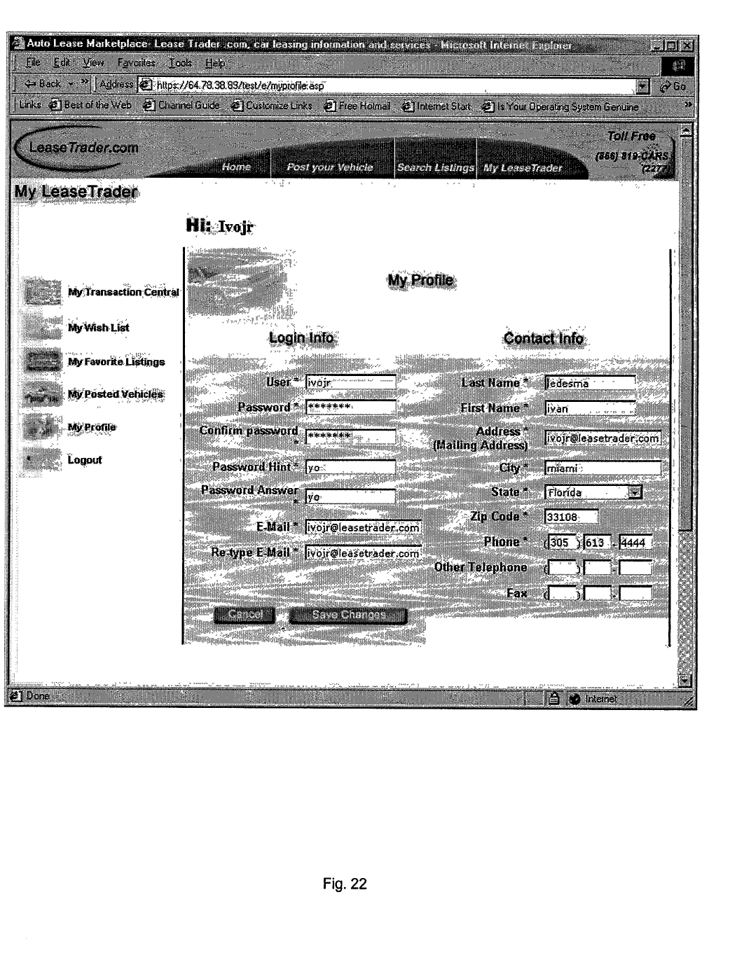

Referring to FIG. 13, which depicts a sample “My Lease Trader” login screen, the system verifies if the user is logged in. If not, the system prompts the user to log in. The user can then access a personalized section (“MyLeaseTrader”). Referring to FIGS. 14-22, the MyLeaseTrader screen is divided into the following areas:

a. My Posted Vehicles. View the number of hits on one's listing, and edit, extend (for example, $20.00 for an additional 60 days) or delete the listing.

b. My Transaction Central.

i. Users can review the status of a credit verification/financing (hereinafter referred to collectively as “credit”) application submitted in connection with a listing. It can be regarding one's own listing or another listing that the user applied for. The system will show if a credit application is pending review.

ii. Access the message center. The message center is online tool to communicate with other parties involved in the transaction and exchange information. The contact information remains anonymous. The moment a message is sent through this medium, the system automatically notifies the recipient via e-mail that there is a new message waiting to be read.

c. My Favorite Listings. Users can view an delete past saved vehicle search results.

d. My Profile. Users can manage and edit contact information including e-mail, telephone number(s), and physical address.

e. My Wish List. Users can create and edit requests to be automatically notified the instant an exact or similar match of a desired lease is inputted into the system.

Dealer Section

The system provides a dealer only section.

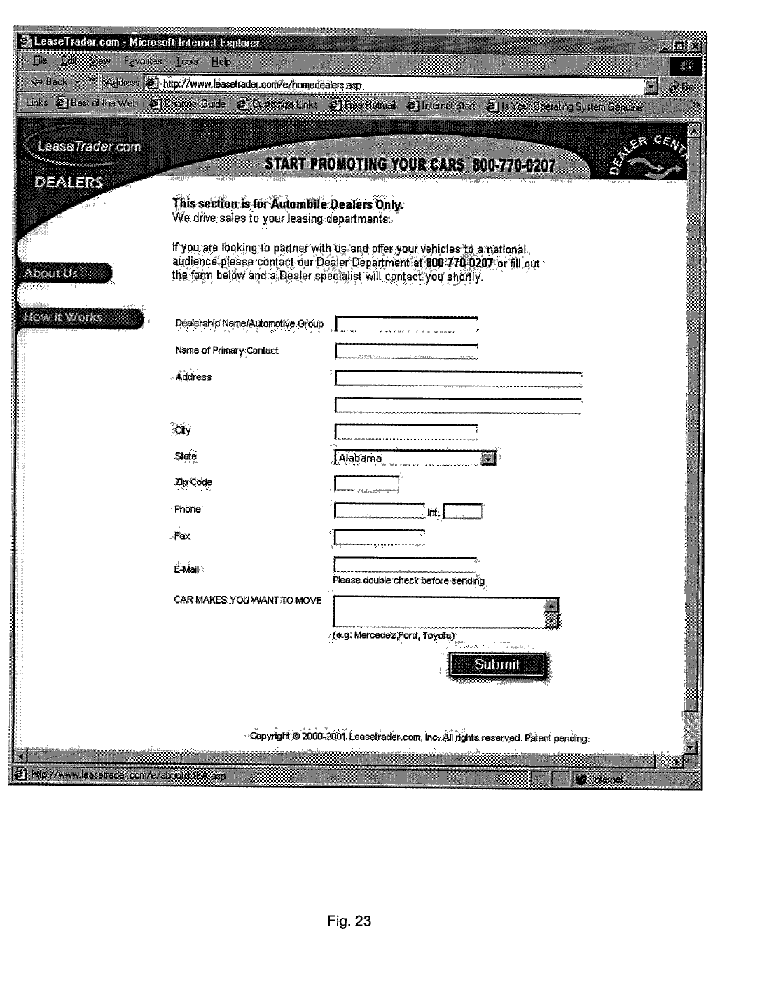

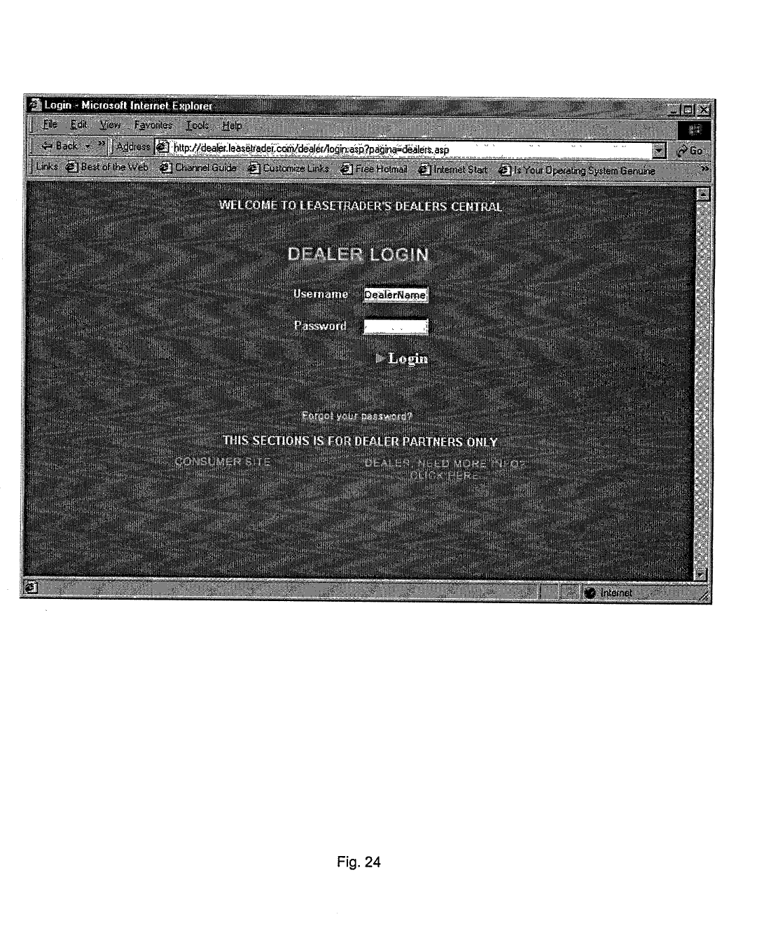

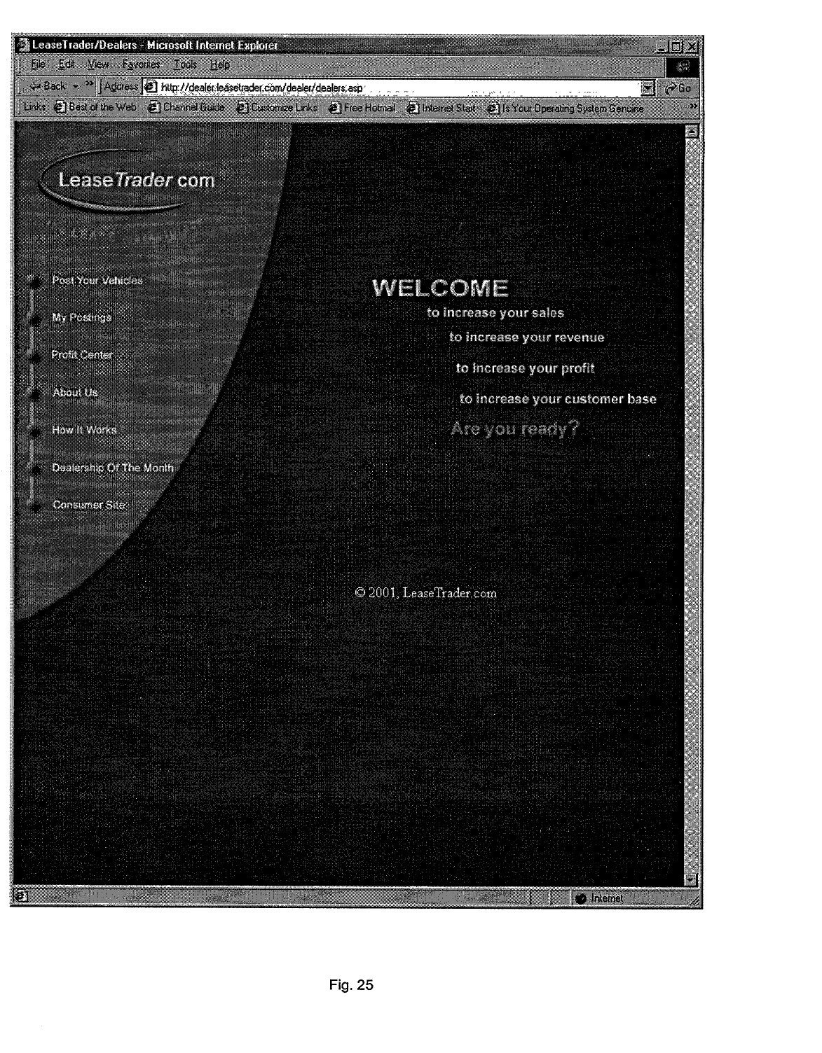

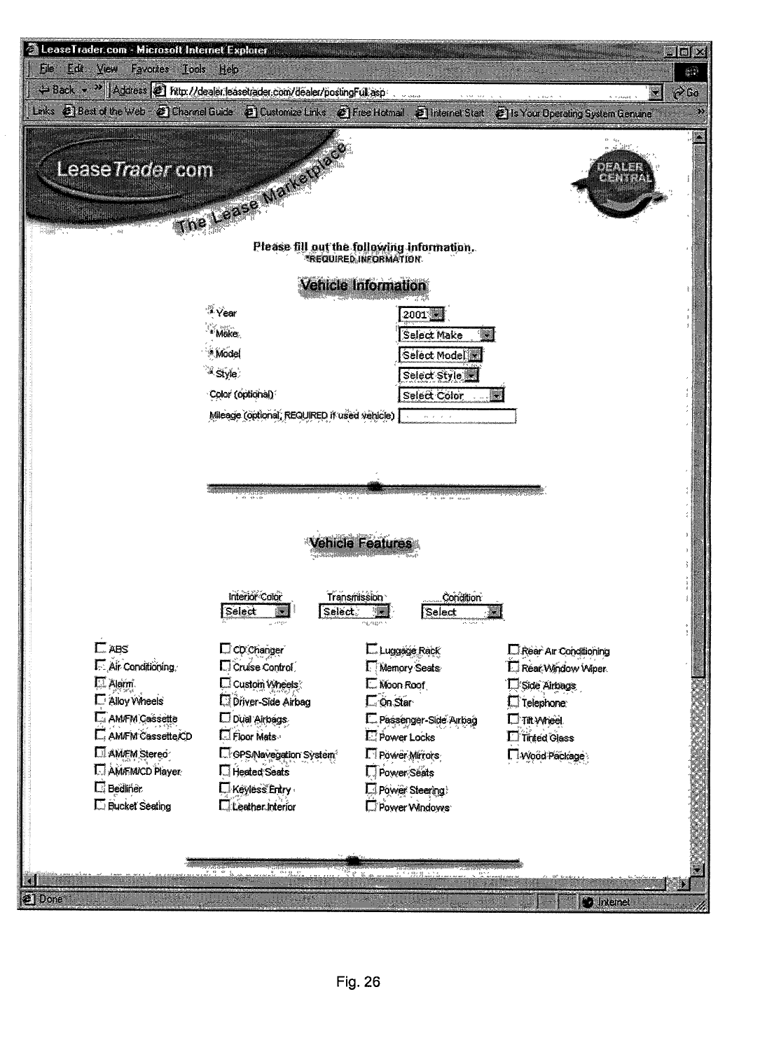

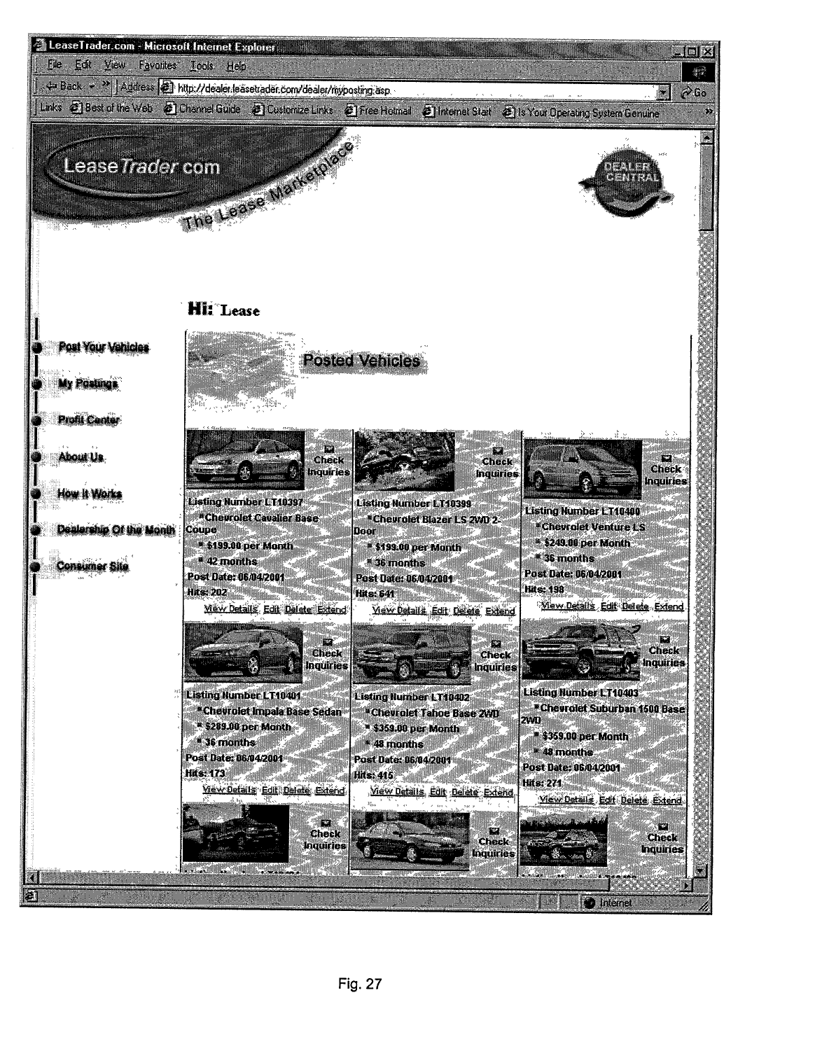

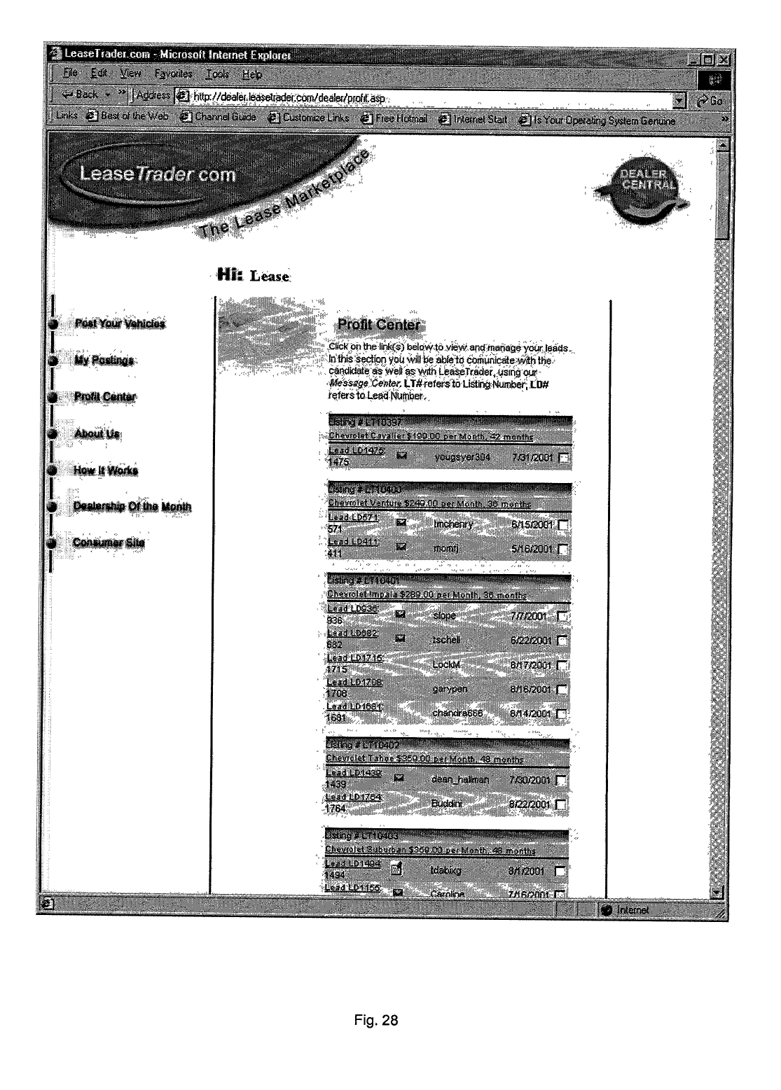

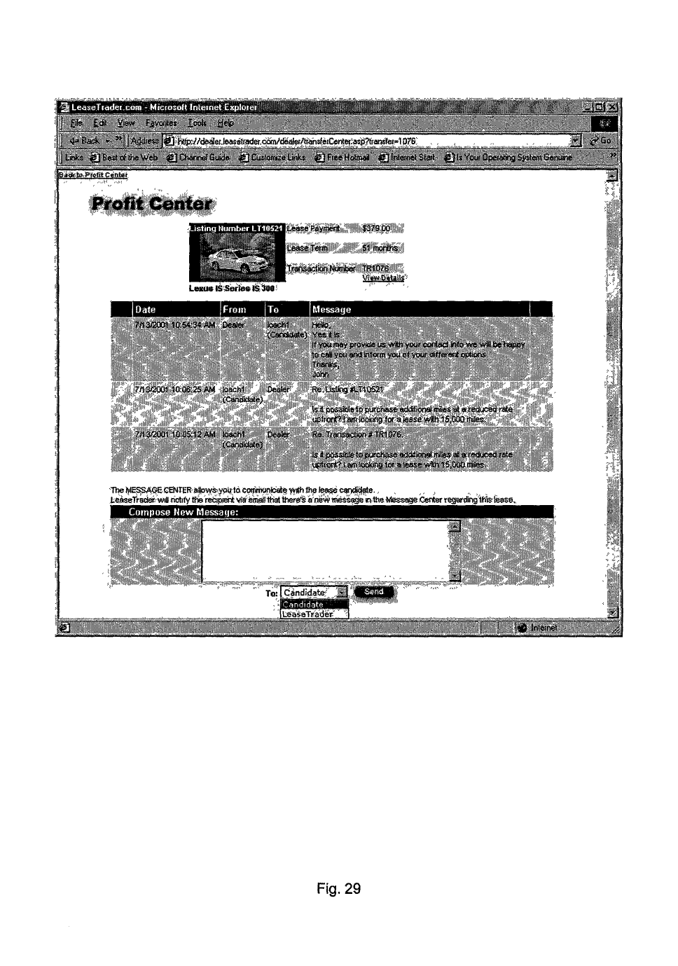

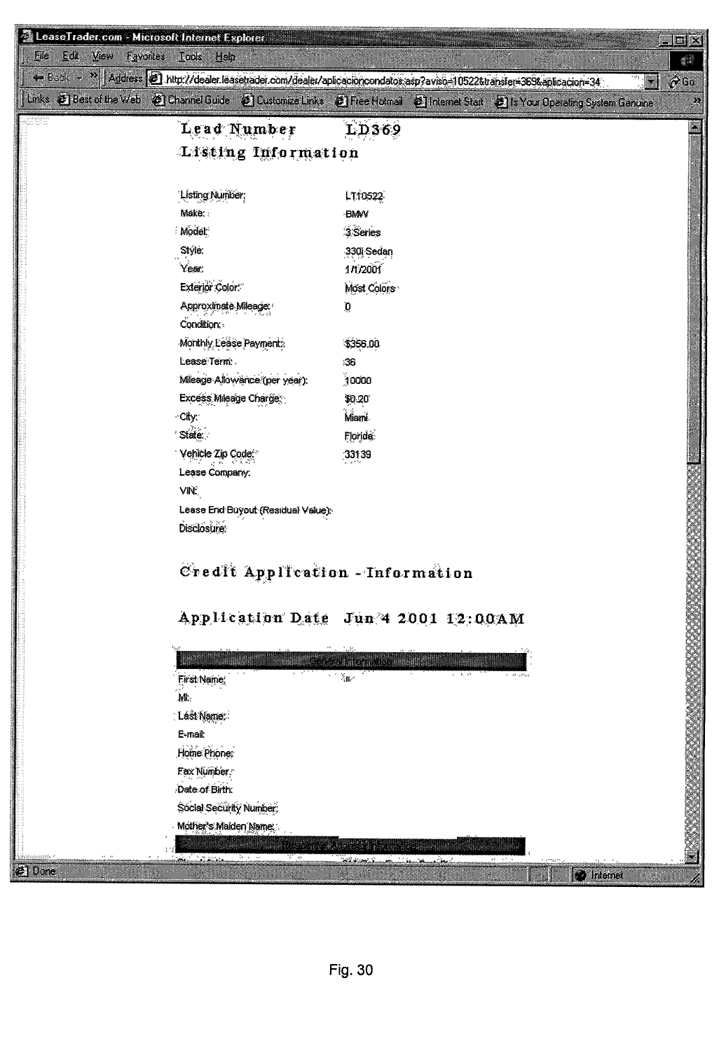

Referring to FIGS. 23-30, dealers log in with user name and password. If they don't have an account with the system, they can fill out a contact form or contact the system directly to set up an account and receive access to their dealer section. The dealer section is preferably divided into the following areas:

Post your Vehicles. Depending on the number of postings allowed in each particular account (e.g., 50 listings) a dealer can add vehicles to the vehicle database and make them available in search results.

My Postings. Dealers can view the number of hits on one's listing, and edit, extend or delete the listing. This feature is important to dealers because it permits them to make changes resulting from changes in their listings to reflect changes in inventory or specials they may be running.

Profit Center.

i. Access the message center. An online tool to communicate with (a) individuals who sent them a message through this feature. The system notifies the dealer via e-mail that there is a new message waiting to be read; (b) contact logged in individuals who viewed their listing. This is of great importance for the dealer because they can contact a prospective lease transferee user who browsed through the dealer's listing but failed to initiate the contact with the dealer. The transferee user's contact information remains anonymous, but the system will automatically notify the consumer via email that there is a new message waiting to be read.

ii. Retrieve and print online credit applications submitted in connection with their listings.

Consumers Looking to Take Over a Lease

Consumers wishing to assume a lease will have the following search options available:

Search available listings. Consumers will be able to search the vehicle information posted by transferors based on any of the following criteria or any combination thereof: make, model, color, year, zip code, state, monthly payment range, number of lease payments remaining.

Search comprehensive third party database of vehicles. Search results will generate pricing, features, and comparison information.

Consumers may select a vehicle from the third party database search and include a request for that vehicle in a wish list. When the vehicle requested becomes available in the transferor listings the consumer will be notified by the system via e-mail and via his/her personal section of the system website.

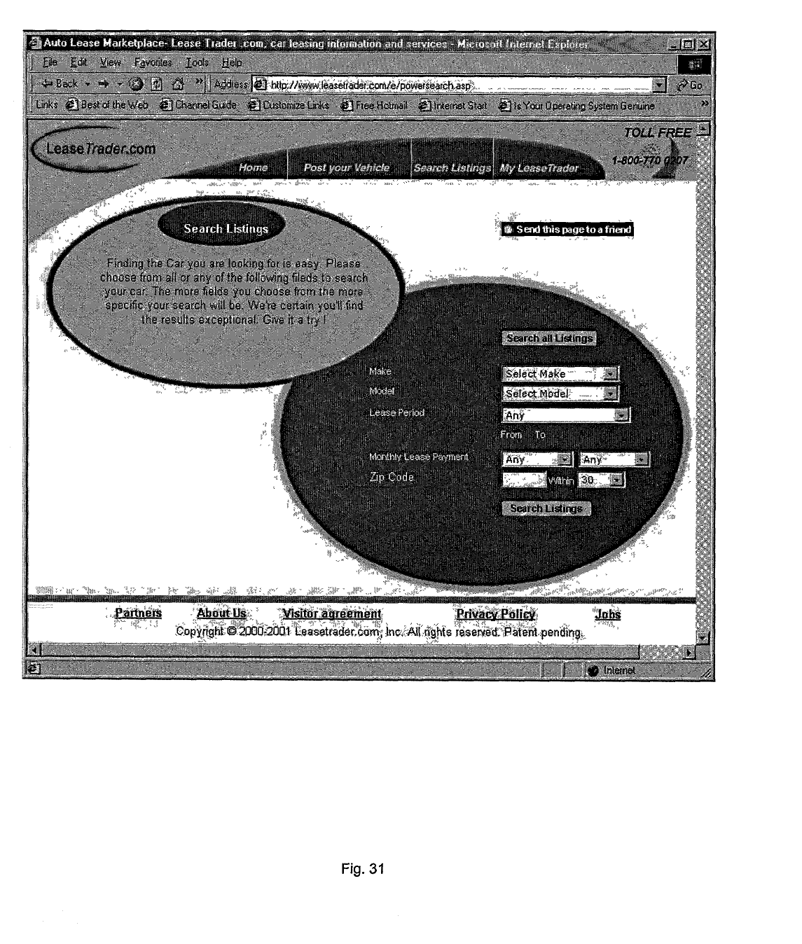

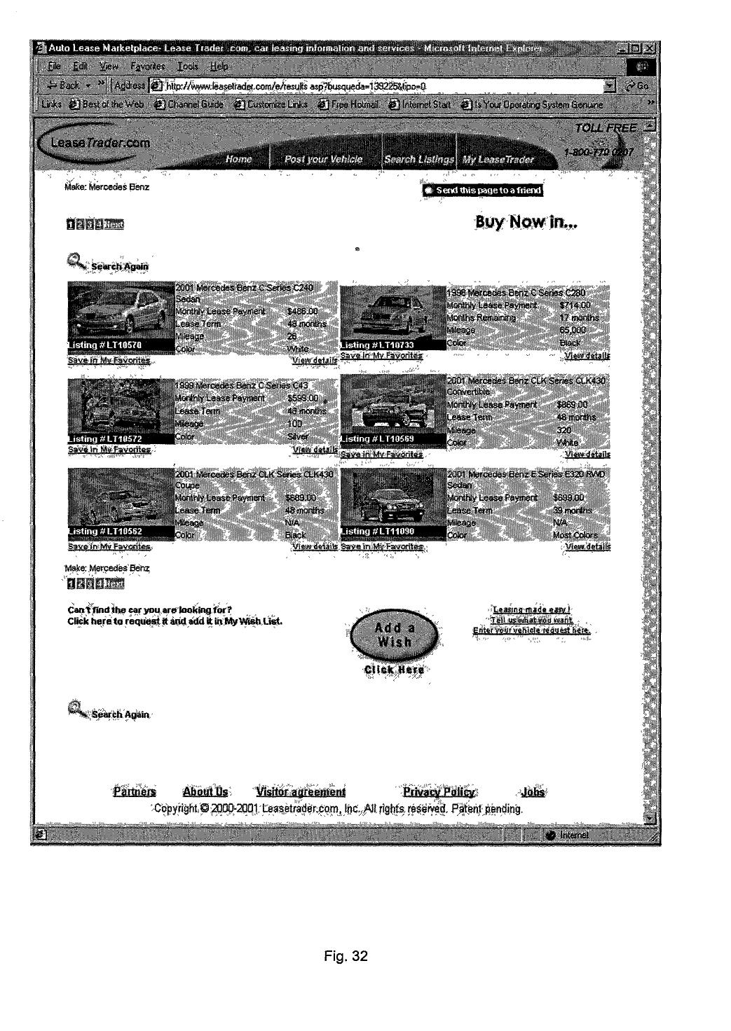

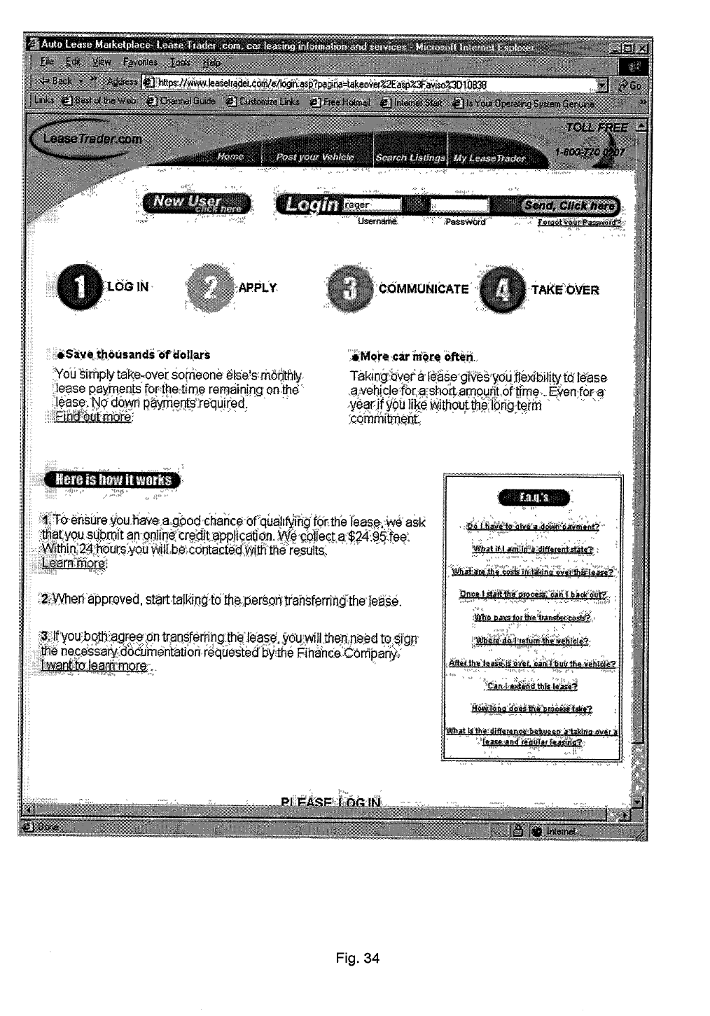

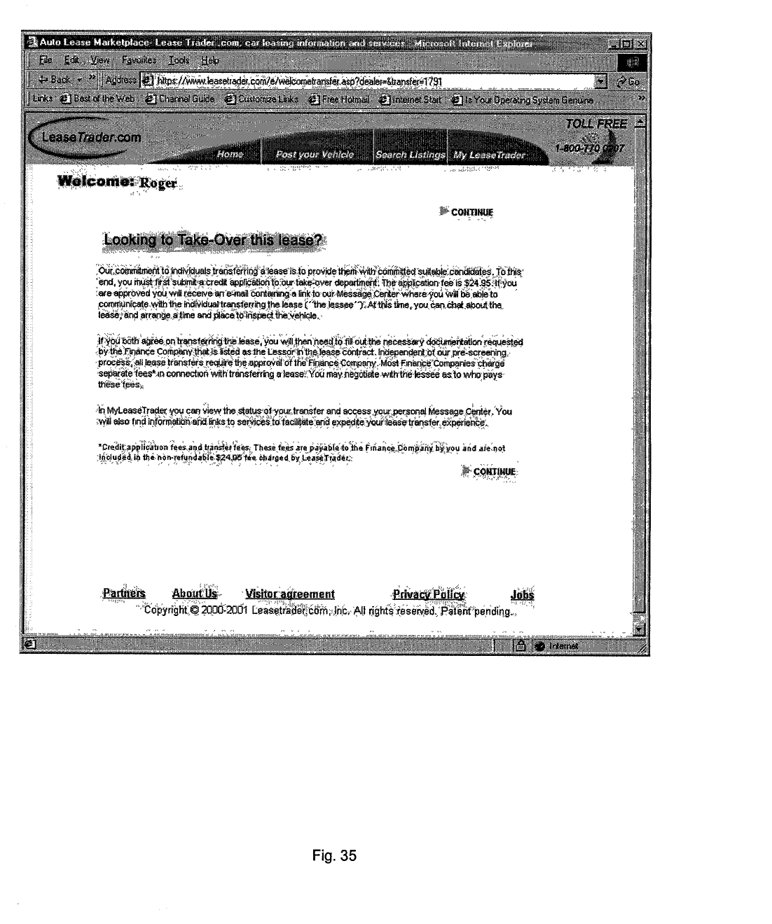

Referring to FIGS. 31-35, transferee users can query the vehicle database based on criteria including but not limited to make, model, lease payment range, time remaining on the lease or lease period, and zip code location.

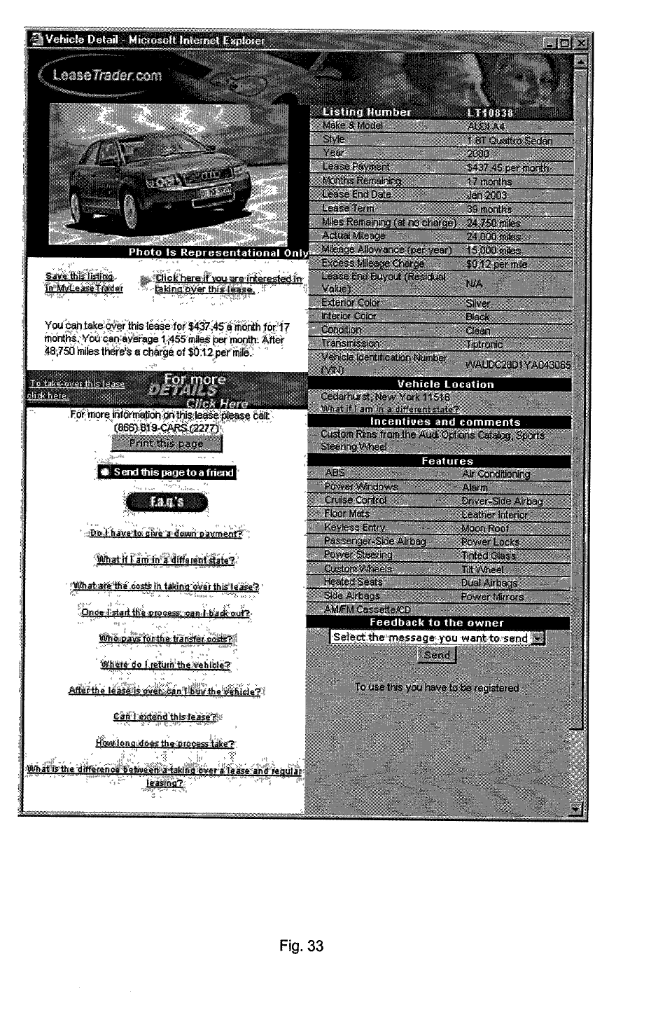

Referring to FIGS. 33, by clicking on the view details link on the search results page, users can see the following information: year, make, mode, style, monthly lease payment, lease term, time remaining on the lease, lease end date, mileage allowance on the vehicle, excess mileage charge, miles remaining at no charge, FAQ's, the lease end buyout, vehicle identification number, city, state and zip code where the vehicle is located, other vehicle features such as ABS, leather seats and airbags, and any incentives or comments included by the lessee to take-over the lease.

Transferee users desiring to take over a lease would click on the link provided therefor; the system will verify if the user is logged in. If not, log in is prompted. The system will then verify if the user is applying for his/her own listing, the system advises user that he/she cannot take-over his own lease. If the user submitted a credit application to take-over a lease within the last 60 days, the system will verify if credit application was approved or denied. If denied, system will advise user that it cannot assist in taking-over the lease requested at this time.

If the prior application was approved, then the transferee user will be immediately directed to the message center located in the MyLeaseTrader area where he/she/it can start communicating with the applicable transferor user. The system will automatically notify the transferor user when the lease take-over candidate sends a message through the message center. If a user has an incomplete credit application in the system (a complete application where the user did not pay the application fee), then system will direct the user to the user's credit application containing all information that was completed in the past.

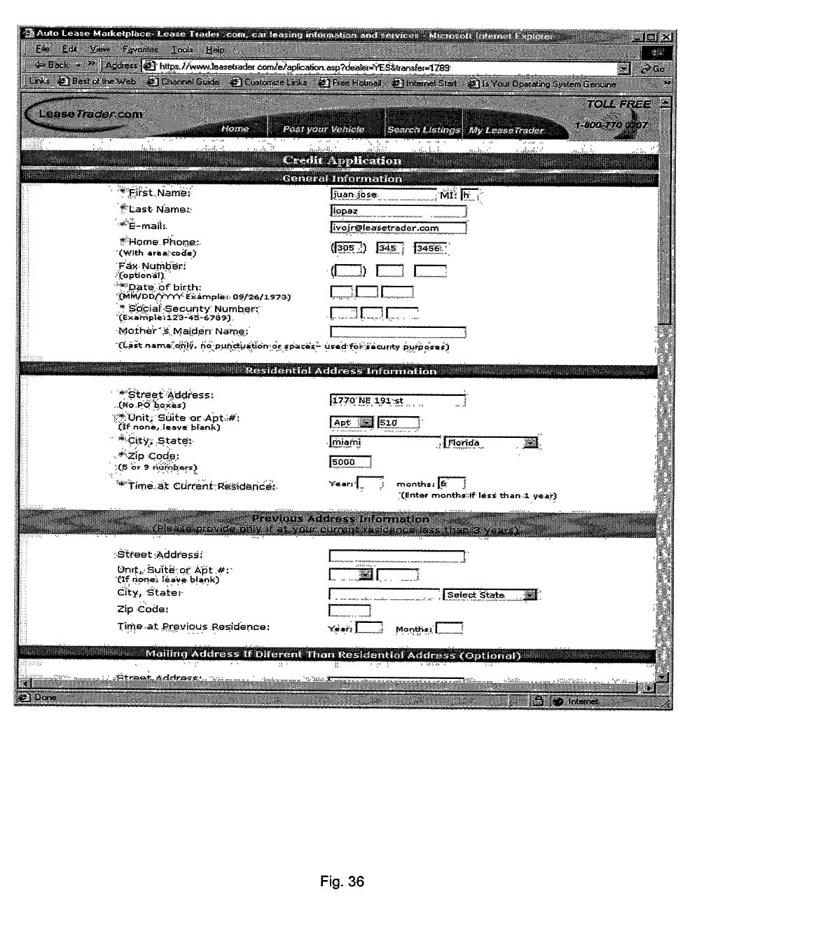

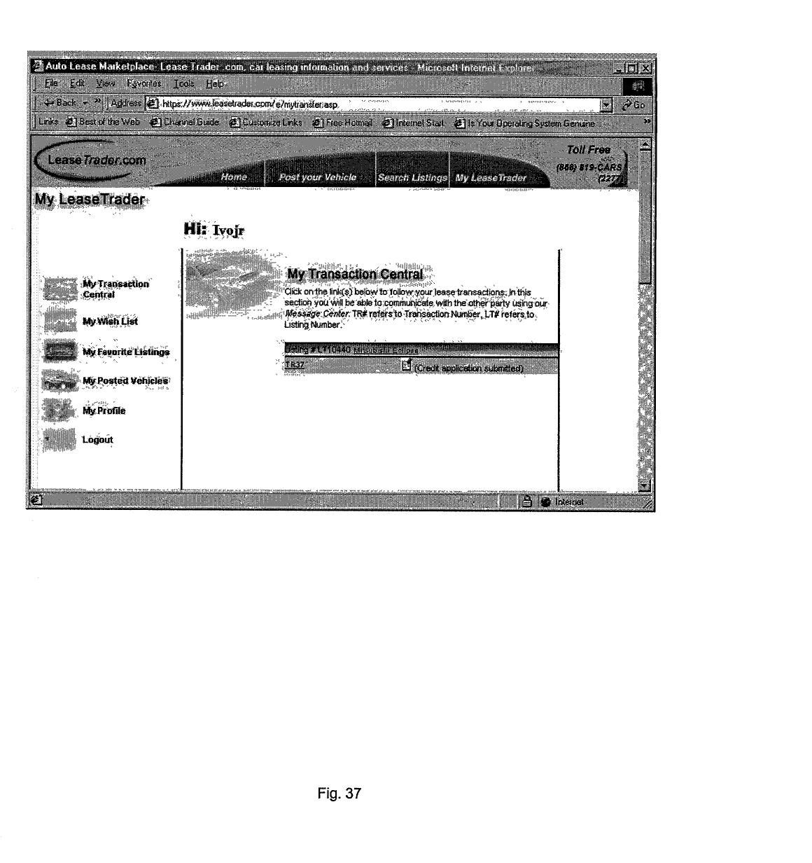

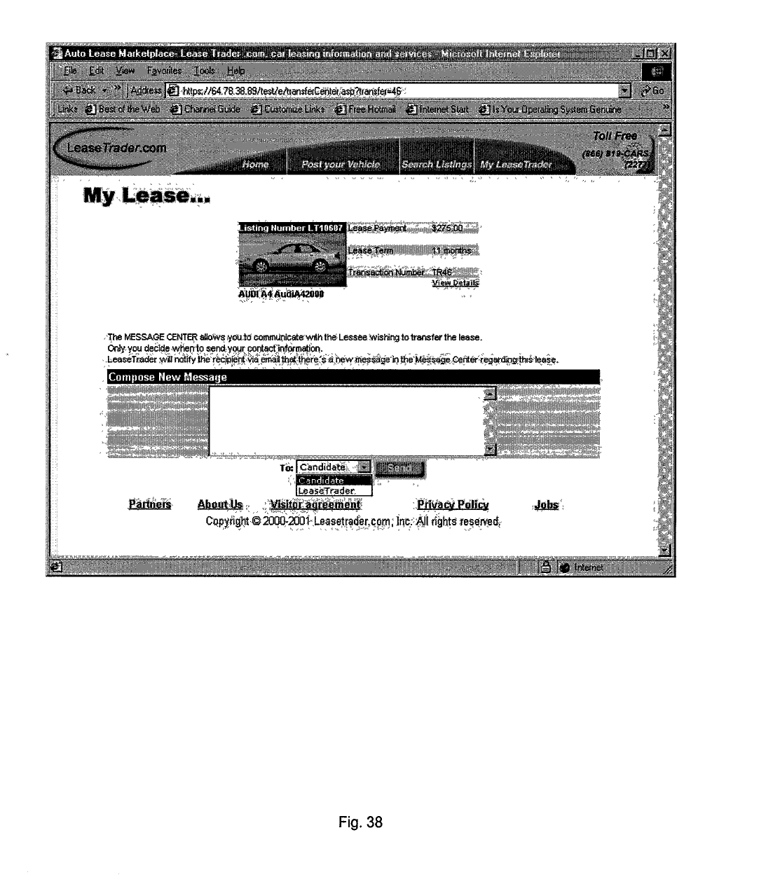

Referring to FIGS. 36-38, upon completing the credit application, user will pay a credit application fee. At this point inside the MyTransaction Central area of both the transferor user and transferee user will see “Application Pending.” The credit application will be reviewed by a system credit specialist who will make a determination if the user or candidate is deemed qualified to take-over the lease requested. If approved, the system will send a message via e-mail directing both the transferor user and the transferee user to the message center inside the MyLeaseTrader area where they will be able to exchange contact information and talk about the lease. If denied, the system will notify the applicant that the credit application was denied and the application will no longer appear as pending in the MyTransaction Central area of both the transferor user and transferee user.

If both the transferor user and transferee user decide to move forward with the lease transfer then: If the transferor user remains personally obligated under the lease, he/she/it can purchase the liability insurance to protect against transferee user default.

The parties can request for the system to assist in the transfer process. The fee collected by the system in connection with providing this service can be paid by either the transferor user, prospective transferee user or both. The transfer assistance service reduces the time to transfer the lease in half. If the service is requested and paid for, the system will then contact the finance company listed as the lessor in the lease contract and coordinate documentation delivery, assist with the completion of the required documents, coordinate between the parties a time and place to inspect and transfer the vehicle. If necessary LeaseTrader will coordinate with inspection and transportation companies as necessary.

Wish List

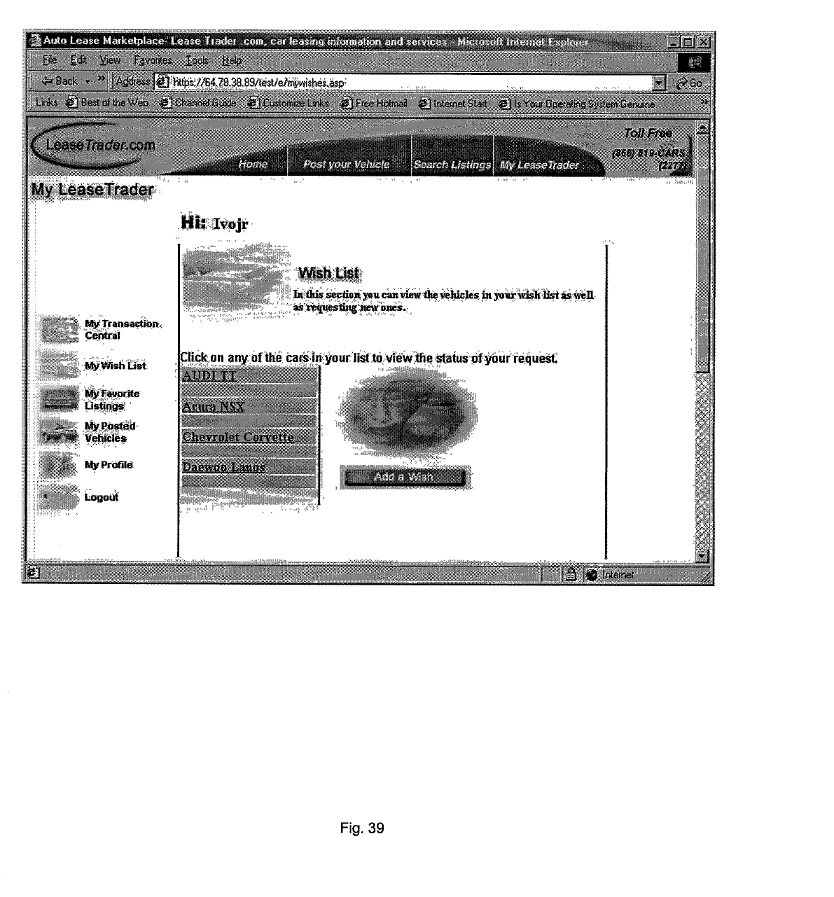

Referring to FIG. 39, in cases where the desired vehicle or lease is not found, the user can click on ADD A WISH. When clicking on this link, the system will verify if the user is logged in. If not, then requires log in. The user will then be directed to the Add a Wish section inside the MyLeaseTrader area where a request can be entered to be notified the instant an exact or similar match to vehicle requested is online. The moment a vehicle is added to the online vehicle database, the system automatically searches for requests for exact or similar matches to the vehicle posted and notifies the requesting parties via e-mail. The e-mail contains a description of the vehicle requested and a link to vehicle details page of the system.

Consumers Searching for a Deal on a Lease Offered by a Dealer

The vehicle database can be queried based on criteria including but not limited to make, model, lease payment range, time remaining on the lease or lease period, and zip code location. By clicking on the view details link on the search results page, users can see the following information: the year, make, model, style, monthly lease payment, lease term, time remaining on the lease, lease end date, mileage allowance on the vehicle, excess mileage charge, miles remaining at no charge, FAQ's, the lease end buyout, vehicle identification number, city, state and zip code where the vehicle is located, features such as ABS, leather seats and airbags, and disclosures required by law including amount due at inception, tax, tag, and state fees.

Apply Online or Dealer Information. When clicking on either link, the system will verify if the user is logged in. if not, then requires log in. (New User is added to User Database). The system will then verify if the user already completed a paid credit application in connection with this listing. If the user completed a prior application for this specific listing, the system will automatically direct the user to the My Transaction Central area where the user will have access to the contact information of the dealer offering the lease and to the message center to communicate with the dealer and/or the system. If user has an incomplete credit application in the system (a complete application where the user did not pay the application fee), then system will direct user to MyTransaction Central area where the user will have access to: (1) the contact information of the dealer offering the lease; (2) an online credit application for the vehicle containing all information that was completed in the past; and (3) the message center to communicate with the dealer and/or the system. If user does not have an incomplete or complete application in connection with this listing, then user will be directed to the MyTransaction Central area where the user will have access to: (1) the contact information of the dealer offering the lease; (2) an online credit application for the vehicle; and (3) to the message center to communicate with the dealer and/or the system.

The user can choose to communicate with the dealer online through the message center. The contact information remains anonymous. The moment a message is sent through this medium, the system automatically notifies the recipient via e-mail that there is a new message waiting to be read) or by telephone or fax. Through the profit center the dealer can retrieve and print online credit applications submitted in connection with their listings. The parties are free to negotiate the terms of the lease.

The system also allows customers to shop online for insurance, car upgrades, extended warranties/maintenance plans, transport and more. The potential transferee can apply online for credit and receive an immediate online response. The potential transferee can check vehicle by VIN number to see if there have been any recalls or problems with the vehicle. Visitors to the website can get comparable market prices on leased and purchase prices of vehicles, as well as trade-in value for a potential trade-in. Before the final assignment of lease, the system assigns an ASE certified technician to check the car and send an online report back to the transferee.

The system offers consumers a way out of their automobile lease without the high overhead associated with breaking a traditional lease. This is achieved by giving consumers a safe, secure way to assign their lease obligations.

The system provides a market place for lease assignments and assumptions that creates early lease termination options while providing a convenient and flexible way for buyers to obtain short-term leases.

The system affords users with a constantly updated, customer-centric online marketplace, that provides the visitor with comprehensive vehicle listings, ease of navigation, fast access to customer support, superior information, personalization and a full range of value-added services, significantly enhancing the lease assignment and/or assumption experience for the consumer. In addition, the system provides a wealth of information about related services ranging from leasing, insurance and automotive service providers to comprehensive data on new and used vehicles, as well as other information relevant to the automobile ownership cycle.

The system, in a preferred embodiment, provides means for searching and selecting, among other items, the following:

1) Vehicle Listings. Users will have various online listing options to post their leased vehicle information.

2) Lemon Check and Detailed Vehicle History Reports.

3) Transferor Insurance.

4) Vehicle Inspection Service.

5) Vehicle Transportation Service.

6) Extended Vehicle Warranty.

7) Automobile Insurance.

8) Finance Company/Bank Processing Fee.

9) Online Credit Check.

10) Car Candy. Auto accessories, high end add-ons, including such things as mag wheels, sound systems, speakers, radar detectors.

11) Merchandising, usually for the make (and model) of vehicle, that includes: T-shirts, key chains, bumper stickers.

12) Various types of auto books, maps, magazines, and music from affiliate sites such as Amazon.com.

13) Car Rental.

Advertisers advertising on the system will be able to offer highly focused advertising campaigns that are made possible because of the wealth of leasing and related information maintained by the system website. The system tracks and stores site usage information and incorporates that information in the advertiser's customer relationship model. Advertisers are able to target their advertisements in direct response to the user's profile and behavior within the site.

Assumption Resquest and Transfer

The transferee user wishing to assume the transferor user's lease will fill out an online credit application and submit it electronically to the system. The system will internally process the application and make a determination to proceed with Applicant based on “beacon score.” The system will notify the transferee of the result and advise transferee of the next steps. The system will notify transferor regarding the foregoing and:

i) Request the transferor user's authorization for system to contact the transferor user's finance company to initiate the lease transfer process.

ii) The system collects a fee from the transferor user to ensure the transferor user's commitment to the transaction.

iii) The system then advises the transferor user regarding next steps.

The system will notify finance company and advise regarding the transferor user's lease transfer request. The system will notify the transferee user of status, collect processing fee from the transferee user and advise regarding next steps. The system will submit the transferee user's credit application to the finance company and advise the transferor user regarding status. The finance company will review and approve the transferee user's credit application and will electronically forward to the transferor user and/or the system the lease assumption documents. The system offers insurance to the transferor user insuring the transferor user against any unfulfilled lease obligations by the transferee user, including insurance covering the prompt and unconditional performance of all of the transferee user's obligations under the lease agreement and that in event of a default in any of the obligations, to pay upon demand the full amount remaining together with a reasonable attorney's fee (if permitted by law) if placed with an attorney for collection. Once the assumption documents are complete and processed by the finance company, the finance company or the system will provide the transferee user with tag and registration documents.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative and other embodiments may be selected without departing from the spirit and scope of the present invention.

What is claimed is:

1. A computerized system for transferring a leased vehicle from a prospective leased vehicle transferor to a prospective leased vehicle transferee comprising:
means for receiving vehicle and lease information submitted electronically by or on behalf of prospective leased vehicle transferors and storing said information in a searchable database;
means for providing said vehicle and lease information electronically to prospective leased vehicle transferees in response to electronic queries to said searchable database submitted by or on behalf of prospective leased vehicle transferees;
means for receiving vehicle selection information submitted electronically by or on behalf of prospective leased vehicle transferors;
means for notifying electronically prospective leased vehicle transferors whose vehicles are selected by prospective leased vehicle transferees of said selection so that the parties can negotiate and complete a leased vehicle transfer transaction;
means for receiving and processing insurance application information submitted electronically by or on behalf of either prospective leased vehicle transferors or prospective leased vehicle transferees with respect to vehicles selected by said prospective leased vehicle transferees for insurance covering the prospective leased vehicle transferor's liability under the prospective leased vehicle transferor's lease agreement for said vehicle in the event of lease payment defaults by the prospective leased vehicle transferee after transfer of said vehicle and lease to said transferee;
means for submitting said insurance application information to one or more insurers for application processing and approval; and
means for arranging for vehicle and lease transfer and insurance document delivery, payment and vehicle delivery.

2. The computerized system of claim 1, wherein said means for receiving vehicle and lease information comprises a series of customized leased vehicle data entry screens made accessible to prospective leased vehicle transferors via a global computer network, whereby prospective leased vehicle transferors can create customized listings for their vehicles.

3. The computerized system of claim 1, wherein said means for notifying electronically prospective leased vehicle transferors whose vehicles are selected by prospective leased vehicle transferees of said selection further comprises messaging means for prospective leased vehicle transferors and prospective leased vehicle transferees to negotiate and complete a leased vehicle transfer transaction.

4. The computerized system of claim 3, wherein said messaging means comprises Internet e-mail communications protocols.

5. The computerized system of claim 3, wherein said messaging means comprises instant peer-to-peer communications protocols.

6. The computerized system of claim 1, further comprising means for prospective leased vehicle transferees to submit their vehicle preferences for matching with leased vehicle data stored in said system's searchable database.

7. The computerized system of claim 1, further comprising means for prospective leased vehicle transferees to submit their lease term preferences for matching with leased term data stored in said system's searchable database.

8. The computerized system of claim 6, further comprising means for notifying prospective leased vehicle transferees of leased vehicle data stored on said system's searchable database that matches said prospective leased vehicle transferees' leased preferences.

9. The computerized system of claim 7, further comprising means for notifying prospective leased vehicle transferees of leased term data stored on said system's searchable database that matches said prospective leased vehicle transferees' lease term preferences.

10. The computerized system of claim 1, further comprising means for receiving financing application information submitted electronically by or on behalf of prospective leased vehicle transferees with respect to vehicles selected by said prospective leased vehicle transferees for financing to pay for transfer of said leased vehicle.
receiving and processing insurance application information submitted electronically by or on behalf of either prospective leased vehicle transferors or prospective leased vehicle transferees with respect to vehicles selected by said prospective leased vehicle transferees for insurance covering the prospective leased vehicle transferor's liability under the prospective leased vehicle transferor's lease agreement for said vehicle in the event of lease payment defaults by the prospective leased vehicle transferee after transfer of said vehicle and lease to said transferee;
submitting said insurance application information to one or more insurers for application processing and approval; and
arranging for vehicle and lease transfer and insurance document delivery, payment and vehicle delivery.
